(19) United States
(12) Patent Application Publication
(10) Pub. No.: US 2026/0281648 A1
(43) Pub. Date: Sep. 17, 2026

(54) INFORMATION PROCESSING APPARATUS AND METHOD, AND PROGRAM

(71) Applicant: Sony Group Corporation, Tokyo (JP)

(72) Inventors: Junichiro OTANI, Tokyo (JP); Mitsuyuki HATANAKA, Kanagawa (JP); Yuji TOKOZUME, Tokyo (JP); Toru CHINEN, Kanagawa (JP)

(73) Assignee: Sony Group Corporation, Tokyo (JP)

(21) Appl. No.: 19/473,674

(22) PCT Filed: Apr. 1, 2024
(86) PCT No.: PCT/JP2024/013448

§ 371 Date: Oct. 8, 2025

(30) Foreign Application Priority Data
Apr. 18, 2023 (JP) 2023-067547

(51) Int. Cl. H04S 7/00

(52) U.S. Cl. CPC H04S 7/30; H04S 2400/11

(57) ABSTRACT

The present technology relates to an information processing apparatus, a method, and a program capable of easily creating high-quality content.

An information processing apparatus includes a control unit that determines an output parameter, which changes in time series, of an object of content on the basis of one or more pieces of attribute information of the content or the object. The present technology can be applied to an information processing apparatus.

### TECHNICAL FIELD

The present technology relates to an information processing apparatus, a method, and a program, and more particularly, to an information processing apparatus, a method, and a program capable of easily creating high-quality content.

### BACKGROUND ART

For example, a technology for automatically performing mixing in object audio, that is, determining three-dimensional position information, a gain, and the like of an object is known (see, for example, Patent Document 1). By using such a technology, a user can easily create content in a short time.

### CITATION LIST

### Patent Document

Patent Document 1: WO 2020/066681 A1

### SUMMARY OF THE INVENTION

### Problems to be Solved by the Invention

Meanwhile, Patent Document 1 proposes a method for determining the three-dimensional position information of the object using a decision tree, but it is not sufficient to consider features of sound important in mixing, and it is difficult to perform high-quality mixing. That is, it is difficult to obtain high-quality content.

The present technology has been made in view of such a situation, and an object thereof is to easily create high-quality content.

### Solutions to Problems

An information processing apparatus according to a first aspect of the present technology includes a control unit that determines an output parameter, which changes in time series, of an object of content on the basis of one or more pieces of attribute information of the content or the object.

An information processing method or a program according to the first aspect of the present technology includes a step of determining an output parameter, which changes in time series, of an object of content on the basis of one or more pieces of attribute information of the content or the object.

In the first aspect of the present technology, an output parameter, which changes in time series, of an object of content is determined on the basis of one or more pieces of attribute information of the content or the object.

An information processing apparatus according to a second aspect of the present technology includes a control unit that determines, as an application pattern, one change pattern among a plurality of change patterns for changing in time series an output parameter of an object of content according to a user operation, and determines the output parameter, which changes in time series, of the object on the basis of the application pattern.

In the second aspect of the present technology, one change pattern among a plurality of change patterns for changing in time series an output parameter of an object of content is determined as an application pattern according to a user operation, and the output parameter, which changes in time series, of the object is determined on the basis of the application pattern.

### BRIEF DESCRIPTION OF DRAWINGS

FIG. 1 is a diagram for explaining creation of a moving object.

FIG. 2 is a diagram for explaining vertical movement.

FIG. 3 is a diagram for explaining horizontal movement.

FIG. 4 is a view for explaining floating movement.

FIG. 5 is a diagram for explaining instantaneous movement.

FIG. 6 is a diagram for explaining solo movement.

FIG. 7 is a diagram illustrating a configuration example of an information processing apparatus.

FIG. 8 is a diagram illustrating a configuration example of an automatic mixing apparatus.

FIG. 9 is a flowchart for explaining automatic mixing processing.

FIG. 10 is a diagram illustrating an example of a decision tree.

FIG. 11 is a diagram for explaining determination of an application pattern.

FIG. 12 is a diagram for explaining editing of the decision tree.

FIG. 13 is a diagram for explaining parameter adjustment of a change pattern.

FIG. 14 is a diagram illustrating an example of editing a manner of motion of an object.

FIG. 15 is a diagram illustrating an example of editing the manner of motion of the object.

FIG. 16 is a diagram for explaining an insertion of a change pattern.

FIG. 17 is a diagram for explaining the insertion of the change pattern.

FIG. 18 is a diagram for explaining the insertion of the change pattern.

FIG. 19 is a diagram for explaining the insertion of the change pattern.

FIG. 20 is a diagram for explaining the insertion of the change pattern.

FIG. 21 is a diagram for explaining the insertion of the change pattern.

FIG. 22 is a diagram for explaining the insertion of the change pattern.

FIG. 23 is a diagram for explaining new registration of the change pattern.

FIG. 24 is a diagram for explaining editing of the change pattern.

FIG. 25 is a diagram illustrating a configuration example of a computer.

### MODE FOR CARRYING OUT THE INVENTION

Embodiments to which the present technology is applied will be described hereinafter with reference to the drawings.

### First Embodiment

### Present Technology

The present technology relates to a method and an apparatus for automatically mixing object audio or assisting mixing.

In particular, the present technology supports content production mainly by automatically generating a time-series change in metadata of an audio object (hereinafter, also simply referred to as an object) of content such as a content using a 3D object audio, or realizing simplification of manual production of metadata. The metadata referred to herein is, for example, three-dimensional position information or a gain of an object.

In the present technology, the three-dimensional position information and the gain (hereinafter, also simply referred to as metadata) of an object are determined on the basis of one or more pieces of attribute information indicating a feature amount of each object or the entire music.

The attribute information includes at least one of a content category indicating the type of content, an object category indicating the type of an object, or an object feature amount that is a scalar value indicating the feature of the object. Furthermore, the content category, the object category, and the object feature amount are expressed by words that are understandable to a user, that is, characters (text information), numerical values, or the like.

In the present technology, by storing, applying, or correcting, as a pattern, a change process of metadata of an object having a time-series change in metadata (hereinafter, also referred to as a moving object), a moving object that does not deviate from a flow of music can be generated, and the production cost of content can be reduced. Here, not deviating from the flow of music means that the motion of the metadata of the moving object does not deviate from the structure (progress) of music including bars, beats, and the like.

In addition, in the present technology, since the change process of metadata can be stored in an easily correctable form, it is possible to generate a moving object suitable for each of many users.

The present technology mainly includes two components: automatic generation of metadata by an algorithm and simplification of manual production using a graphical user interface (GUI), and particularly has the following features.

### (Feature 1) Automatic Generation by Algorithm

### Feature 1.1

A target object, a target section, and a manner of motion to be set as a moving object are automatically determined by using content type information, instrument type information, and a plurality of other feature amounts, and a parameter (metadata) changing in time series is generated.

### Feature 1.2

The time series change of the metadata generated by the algorithm may be any of predetermined patterns of “vertical movement”, “horizontal movement”, “floating movement”, “instantaneous movement”, or “solo movement”.

### Feature 1.3

The above-described pattern may be automatically assigned to the target section to generate the output (metadata).

### Feature 1.4

In the automatic assignment of the above-described pattern, a result of analyzing features of music may be used.

### Feature 1.5

In the above-described algorithm, an expression that is understandable to the user is used, and may be able to be edited by the user.

### Feature 1.6

The metadata, which changes in time series, predetermined as the above-described pattern may be able to be edited by the user.

### (Feature 2) Simplification of Manual Production Using GUI

### Feature 2.1

Time-series change patterns of various pieces of metadata based on a plurality of predefined representative manners of motion are prepared in advance and selected by the user.

### Feature 2.2

The pattern selected by the user is applied with assistance so as to be easily adapted to the musical configuration and section of the signal of the target object.

### Feature 2.3

The above-described pattern may be a pattern described in (Feature 1.2).

### Feature 2.4

The above-described pattern may be able to be edited, added, or deleted by the user.

### Feature 2.5

Information such as an insertion place may be able to be edited in units of patterns after application.

Furthermore, a related function for being utilized by more users may be provided in accordance with the above-described technology.

### 1. Background

For example, 3D audio can provide a new music experience in which sound is heard from all directions at 360°, which is different from conventional 2-channel audio. In particular, in object audio which is a format of 3D audio, various sounds can be expressed by arranging a sound source (audio object) at an arbitrary position in a space.

In order to further spread the 3D audio, it is required to create a lot of pieces of high-quality content. In this regard, mixing work, that is, the work of determining the three-dimensional position and the gain of each of the objects is important. There are people called mixing engineers who specialize in the mixing work.

A general method for producing 3D audio content is to convert existing 2-channel audio content into 3D audio content. At that time, the mixing engineer receives the existing 2-channel audio data separately for every object. Specifically, for example, audio data of each object such as a kick object, a base object, and a vocal object is supplied.

Next, the mixing engineer listens to the sound of the entire content and each object, and analyzes, for example, the type of the content, such as genre and tone, and the type of each object, such as an instrument type. Furthermore, the mixing engineer also analyzes the feature of the sound of each object, for example, a rise or a duration.

Then, on the basis of analysis results thereof, the mixing engineer determines the position and the gain when each object is arranged in a three-dimensional space. Even among objects of the same instrument type, appropriate three-dimensional position and gain change depending on the feature of sound of the object, the genre of music, and the like.

Furthermore, in music, a method of manually changing the three-dimensional position and the gain of an object temporally is often used in the current market. After each track and the entire music are analyzed along the production flow described above, the three-dimensional position and the gain are manually changed temporally based on the analysis result, so that a listening feeling can be changed, and the excitement of the music and the like can be presented.

The mixing work described above requires a high degree of experience, knowledge, and time for listening to the sound in this way and determining the three-dimensional position and the gain based on the listening.

Depending on the scale of content, it generally takes several hours for the mixing engineer to mix one piece of content. If the mixing work can be automated, 3D audio content can be produced in a short time, leading to further spread of 3D audio.

In this regard, for example, it is conceivable to analyze various feature amounts of music and generate a three-dimensional position and a gain of an object by using the feature amounts. Furthermore, the analysis result of the feature amounts can also be applied to a method of temporally changing the three-dimensional position and the gain of the object.

In the present technology, information corresponding to a temporal change such as the three-dimensional position and the gain of the object is also provided. Although there are an infinite number of methods for changing the three-dimensional position and the gain, in the present technology, these methods are classified into a plurality of patterns, and it is determined which pattern a target sound or a target section is similar to, thereby determining how to change the three-dimensional position and the gain.

Therefore, it is possible to create content by slightly modifying a basic pattern by the user, and it is possible to support the production of 3D audio without impairing the user's creativity, improve the quality, and reduce the production cost. That is, high-quality content can be easily created.

Here, there are individual differences in the idea of mixing and the tendency of mixing among mixing engineers. For example, some mixing engineers are skilled at mixing pop music, and some mixing engineers are skilled at mixing hip hop music.

If genres are different, features of sounds are different even for the same instrument type, or completely different types of instruments are used in the first place, so how to listen to sounds during mixing varies depending on mixing engineers. As a result, completely different temporal changes of the three-dimensional position are set in the audio object of the same music, and different music expressions may be performed.

Thus, when there is only one behavior of pattern application of a temporal change of metadata, it is not be possible for many mixing engineers to use it with satisfaction. Therefore, there is a demand for a technology that allows the behavior of applying the pattern of the temporal change to be adapted to the user's preference.

In this regard, in the present technology, it is possible for each user to add, modify, or delete a classification rule (application behavior) into a pattern as appropriate. That is, it is possible to construct a pattern determination rule that is understandable to the user by using the analysis feature amount described above. Therefore, it is possible to optimize countless and constantly changing methods of metadata for each user, and it is possible to provide production support to more users.

### 1.1. Production Example of Moving Object

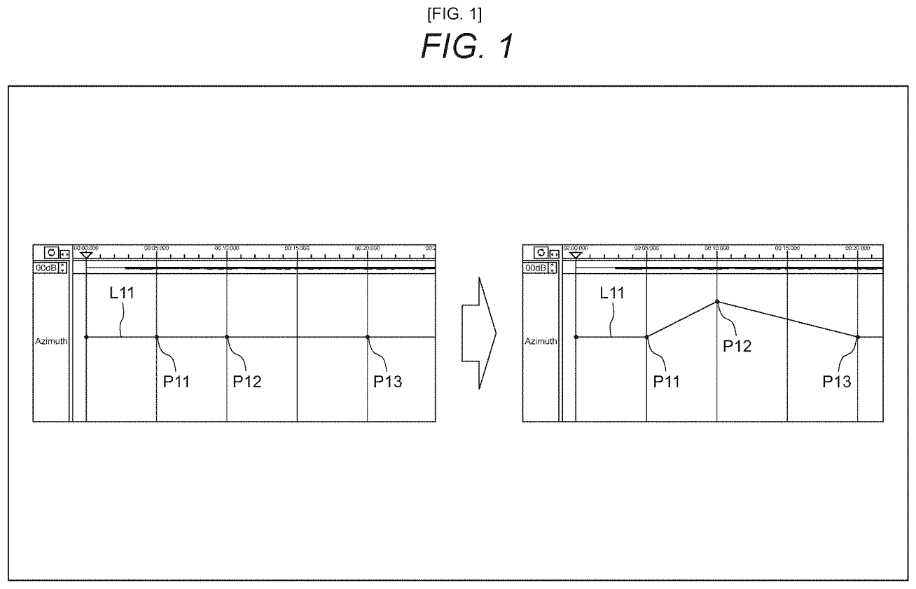

An example of the creation of the moving object is as illustrated in FIG. 1, and the user provides (sets) a change point for a place where the user desires to change the metadata on the graph representing the temporal change of the metadata. It is necessary to insert as many change points as the number of points (times) at which the change amount of each piece of metadata changes. When providing a desired number of change points, the user adjusts the position of each change point such that the change point becomes a change that the user wants to add to the metadata.

In the example of FIG. 1, a graph L11 illustrates a temporal change of a horizontal angle (hereinafter, also referred to as an azimuth) which is a parameter indicating a horizontal direction position of an object as metadata.

For example, it is assumed that the user wants to add, to azimuth, a change in which azimuth is increased from 0° to 90° over 5 seconds and then azimuth is returned to 0° over 10 seconds in a state where the graph L11 as illustrated on the left side in the drawing is displayed.

In such a case, the user provides three change points P11 to P13 on the graph L11 representing the temporal change of azimuth.

Then, as illustrated on the right side in the drawing, the user adjusts a value at a start point, that is, the change point P11 to azimuth=0, a value at the change point P12 5 seconds after the start point to azimuth=90, and a value at the change point P13 10 seconds after the change point P12 to azimuth=0. Therefore, it is possible to generate an object in which a three-dimensional position as metadata, more specifically, azimuth changes as desired.

However, in a scene of actual content production, it is not always as simple as the examples described above.

For example, there is a case where a plurality of pieces of metadata other than azimuth is edited at the same time. In a case where a smooth change is desired, it is necessary to provide a considerably large number of change points. Furthermore, in a case where the change points are adjusted, it is necessary to perform adjustment on all the change points.

In this regard, in the present technology, as described below, a predetermined motion is stored as a pattern (hereinafter, also referred to as a change pattern), and a change point group can be inserted, added, and edited as the change pattern, so that the production cost can be reduced.

Hereinafter, specific technical content will be described from the description of the change pattern of the moving object.

### 2. Change Pattern of Moving Object

The change pattern of the moving object is obtained by combining information of the temporal change of the metadata such as the three-dimensional position and the gain of the moving object into one.

That is, the change pattern is a typified pattern of changes in the time direction of parameters that can change in time series, such as a gain, an azimuth representing a three-dimensional position, an elevation, and a radius. Thus, it can be said that the change pattern is a change pattern when one or more parameters constituting the metadata is changed in time series.

Examples of the change pattern include vertical movement, horizontal movement, floating movement, instantaneous movement, and solo movement.

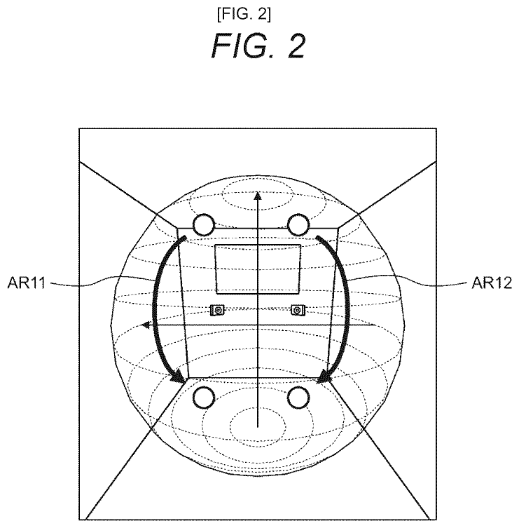

Hereinafter, details of each change pattern will be described with reference to FIGS. 2 to 6. Note that FIGS. 2 to 6 illustrate a virtual three-dimensional space in which the moving object is arranged, and each circle arranged in the space represents the moving object, that is, the three-dimensional position of the moving object in the space.

Furthermore, the change pattern may be manually generated by the user or may be automatically generated. In a case where the change pattern is automatically generated, the temporal change of the metadata may be estimated from the past change information of the metadata by using machine learning. By making it possible to add a new change pattern, compatibility and extensibility can be secured. Moreover, in the following, the change in the three-dimensional position of the moving object will be described as the change of the metadata in each change pattern, but the gain of the moving object can also be changed with the three-dimensional position. Furthermore, it is also possible to change metadata other than the three-dimensional position and the gain of the moving object, and it is also possible for a system or the user to select or set a target of the metadata to be changed. For example, as another example of the metadata that changes the time series of the moving object, a spread indicating how widely the object spreads, the priority of the object, or the like can be considered.

### Vertical Movement

The vertical movement which is one of the change patterns is, for example, a pattern in which a motion in which a change in sound in an up-down direction is emphasized is performed as indicated by an arrow AR11 or an arrow AR12 in FIG. 2, for example. In this example, for example, the three-dimensional position of the moving object moves downward as indicated by the arrow AR11.

In the vertical movement as a change pattern, the moving object mainly moves unilaterally, such as downward (downward movement) or upward (upward movement), but the upward and downward movements may be switched in the middle. Furthermore, although there is a case where the motion of the moving object in a left-right direction is added, such a motion (movement) in the left-right direction is added to emphasize a motion in the up-down direction. In the vertical movement, in many cases, the moving object moves in a short time of two bars or less.

### Horizontal Movement

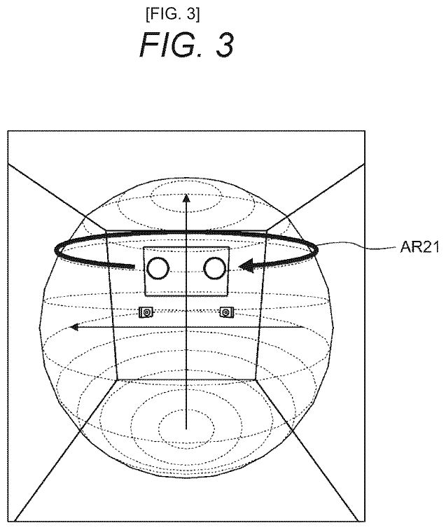

The horizontal movement as the change pattern is, for example, a pattern in which a motion in which a change in sound in the left-right direction is emphasized is performed as indicated by an arrow AR21 in FIG. 3. In this example, the three-dimensional position of the moving object is rotated and moved in the horizontal direction as indicated by an arrow AR21.

In the horizontal movement, the moving object mainly moves unilaterally such as right rotation or left rotation, but the moving direction may be switched in the middle. Furthermore, although there is a case where the motion of the moving object in the up-down direction may be added, such a motion in the up-down direction is added to emphasize a motion in the left-right direction. In the horizontal movement, the moving object often moves with periodicity, such as one rotation of the moving object in a section having a certain length, such as in four bar units.

### Floating Movement

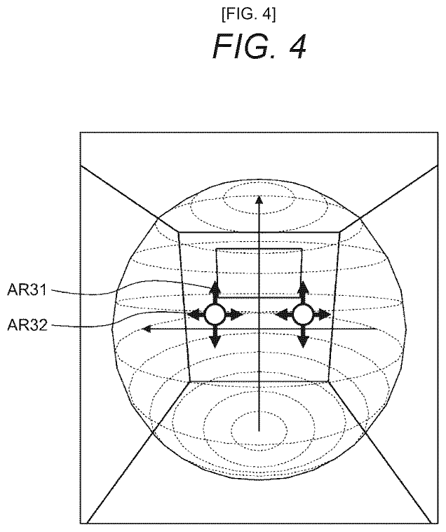

The floating movement as the change pattern is, for example, a pattern in which an object (sound) slightly moves up, down, left, and right as indicated by arrows AR31 and AR32 in FIG. 4.

In the floating movement, a predetermined reference point is determined, and the moving object moves up, down, left, and right with periodicity around the reference point. In this example, the three-dimensional position of the moving object slightly moves in the up-down direction as indicated by the arrow AR31, and also slightly moves in the left-right direction as indicated by the arrow AR32.

In the floating movement, the moving object often moves in one period in a section having a certain length such as eight bar units. The floating movement may be accompanied by a change only in the up-down direction or the left-right direction, or the position may be changed simultaneously in each direction of the up-down and left-right directions.

### Instantaneous Movement

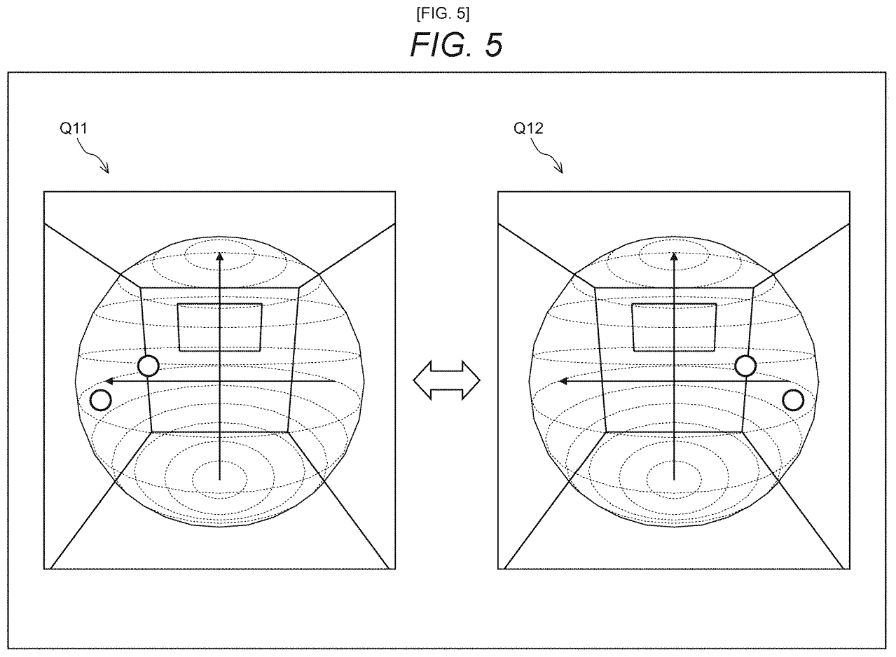

The instantaneous movement as the change pattern is, for example, a pattern in which a motion is performed in a short time in which the process of changing the position of the object (sound) is imperceptible as illustrated in FIG. 5. That is, the instantaneous movement as the change pattern is a pattern in which the position of the sound (object) instantaneously (discontinuously) moves.

In the example of FIG. 5, the position of the moving object instantaneously moves from the position indicated by an arrow Q11 to the position indicated by an arrow Q12. Moreover, thereafter, for example, the position of the moving object may instantaneously move from the position indicated by the arrow Q12 to the position indicated by the arrow Q11.

In the instantaneous movement, there are a plurality of movement destinations of the moving object, and the moving object instantaneously moves to each movement destination every time a section having a certain length such as four bar units ends. Furthermore, in the instantaneous movement, there is periodicity in the movement order of the moving object, that is, in what order the moving object moves to each of the plurality of movement destinations.

### Solo Movement

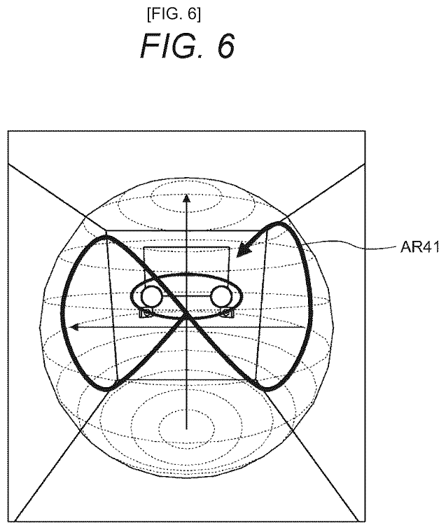

The solo movement as the change pattern is, for example, a pattern in which an object (sound), that is, a sound image (position of sound) freely moves as seen in a solo part within music, such as those illustrated in FIG. 6.

FIG. 6 illustrates a state where two moving objects move continuously together along an arrow AR41. In the solo movement, the moving object continuously moves up, down, left, and right, and the moving speed or the moving direction of the moving object changes intermittently in many cases, and the moving amount of the moving object increases according to the excitement of the solo part in the music.

Note that, in the movement of the moving object by the solo movement, it is conceivable to move a plurality of moving objects together.

Here, the plurality of moving objects to be moved together can be, for example, a plurality of objects belonging to the same track, a plurality of objects belonging to a plurality of highly relevant tracks, or the like. In one track, for example, an object of sound of each channel such as an L channel and an R channel for one instrument or the like belongs.

Furthermore, when a plurality of moving objects is moved together, the plurality of moving objects may be moved while a relative positional relationship between the plurality of moving objects is maintained, or may be moved while the relative positional relationship between the plurality of moving objects is slightly changed. That is, a plurality of moving objects may perform exactly the same motion, or a plurality of moving objects may perform substantially the same motion.

### 3. Automatic Application of Change Pattern by Algorithm

Here, an example in which the change pattern described in “2. Change Pattern of Moving Object” is automatically applied to the object by using the automatic application algorithm of the change pattern will be described.

### 3.1. Outline

### Configuration Example of Information Processing Apparatus

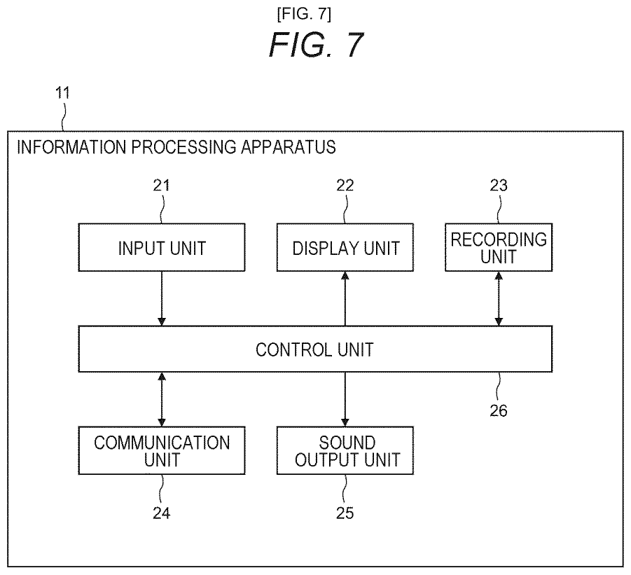

FIG. 7 is a diagram illustrating a configuration example of an information processing apparatus to which the present technology is applied.

An information processing apparatus 11 illustrated in FIG. 7 includes, for example, a computer or the like. The information processing apparatus 11 includes an input unit 21, a display unit 22, a recording unit 23, a communication unit 24, a sound output unit 25, and a control unit 26.

The input unit 21 includes, for example, an input device such as a mouse or a keyboard, and supplies a signal corresponding to a user operation to the control unit 26.

The display unit 22 includes a display, and displays various images (screens) such as a display screen of a 3D audio production/editing tool under the control of the control unit 26. For example, the recording unit 23 records various data such as audio data of each object and a program for realizing a 3D audio production/editing tool, and supplies the recorded data to the control unit 26 as necessary.

The communication unit 24 communicates with an external apparatus. For example, the communication unit 24 receives audio data of each object transmitted from an external apparatus and supplies the audio data to the control unit 26, or transmits data supplied from the control unit 26 to an external apparatus.

The sound output unit 25 includes a speaker and the like, and outputs sound on the basis of the audio data supplied from the control unit 26.

The control unit 26 controls the entire operation of the information processing apparatus 11. For example, the control unit 26 causes the information processing apparatus 11 to function as an automatic mixing apparatus by executing a program for realizing a 3D audio production/editing tool recorded in the recording unit 23.

### Configuration Example of Automatic Mixing Apparatus

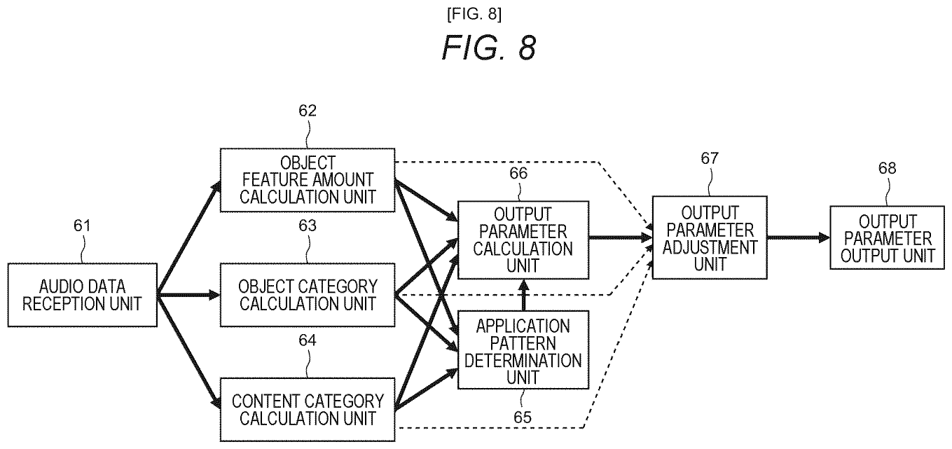

By the control unit 26 executing the program, for example, the automatic mixing apparatus illustrated in FIG. 8 is realized.

The automatic mixing apparatus in FIG. 8 includes an audio data reception unit 61, an object feature amount calculation unit 62, an object category calculation unit 63, a content category calculation unit 64, an application pattern determination unit 65, an output parameter calculation unit 66, an output parameter adjustment unit 67, and an output parameter output unit 68 as functional configurations.

The audio data reception unit 61 acquires audio data of each object of the 3D audio content and supplies the audio data to the units from the object feature amount calculation unit 62 to the content category calculation unit 64.

The object feature amount calculation unit 62 calculates an object feature amount that is a scalar value indicating a feature of an object on the basis of the audio data from the audio data reception unit 61, and supplies the object feature amount to the application pattern determination unit 65, the output parameter calculation unit 66, and the output parameter adjustment unit 67.

The object category calculation unit 63 calculates an object category indicating a type of an object on the basis of the audio data from the audio data reception unit 61, and supplies the object category to the application pattern determination unit 65, the output parameter calculation unit 66, and the output parameter adjustment unit 67.

The content category calculation unit 64 calculates a content category indicating a type of content such as music, on the basis of the audio data from the audio data reception unit 61, and supplies the content category to the application pattern determination unit 65, the output parameter calculation unit 66, and the output parameter adjustment unit 67.

The application pattern determination unit 65 determines a change pattern to be applied to each object on the basis of at least one of the object feature amount from the object feature amount calculation unit 62, the object category from the object category calculation unit 63, or the content category from the content category calculation unit 64, and supplies the determination result to the output parameter calculation unit 66.

The output parameter calculation unit 66 calculates an output parameter by applying a change pattern to an object on the basis of the determination result from the application pattern determination unit 65, and supplies the output parameter to the output parameter adjustment unit 67. That is, the output parameter calculation unit 66 calculates the output parameter by using at least one of the object feature amount from the object feature amount calculation unit 62, the object category from the object category calculation unit 63, or the content category from the content category calculation unit 64, a function defined for every change pattern, and the like.

The output parameter is one parameter constituting the metadata of the object. Specifically, for example, three-dimensional position information indicating a position of an object in a three-dimensional space (three-dimensional position), more specifically, at least one of an element (coordinate) constituting the three-dimensional position information or a gain of audio data of the object is used as the output parameter.

As an example, the three-dimensional position information is, for example, polar coordinates indicating the position of the object in a polar coordinate system including an azimuth indicating the position of the object in the horizontal direction, an elevation indicating the position of the object in the vertical direction, a radius indicating the distance from the reference position of the object, and the like. Note that, as an example of the output parameter that changes in time series, spread information indicating how widely the object spreads or the priority information of the object may be calculated in addition to the three-dimensional position information. In addition, for example, various kinds of metadata defined by international standard MPEG-H 3D Audio or the like may be used as the output parameter.

The output parameter adjustment unit 67 adjusts the output parameter from the output parameter calculation unit 66 by using at least one of the object feature amount from the object feature amount calculation unit 62, the object category from the object category calculation unit 63, or the content category from the content category calculation unit 64 as necessary, and supplies the adjusted output parameter to the output parameter output unit 68. The output parameter output unit 68 outputs the output parameter supplied from the output parameter adjustment unit 67 as a final output parameter.

### Description of Automatic Mixing Processing

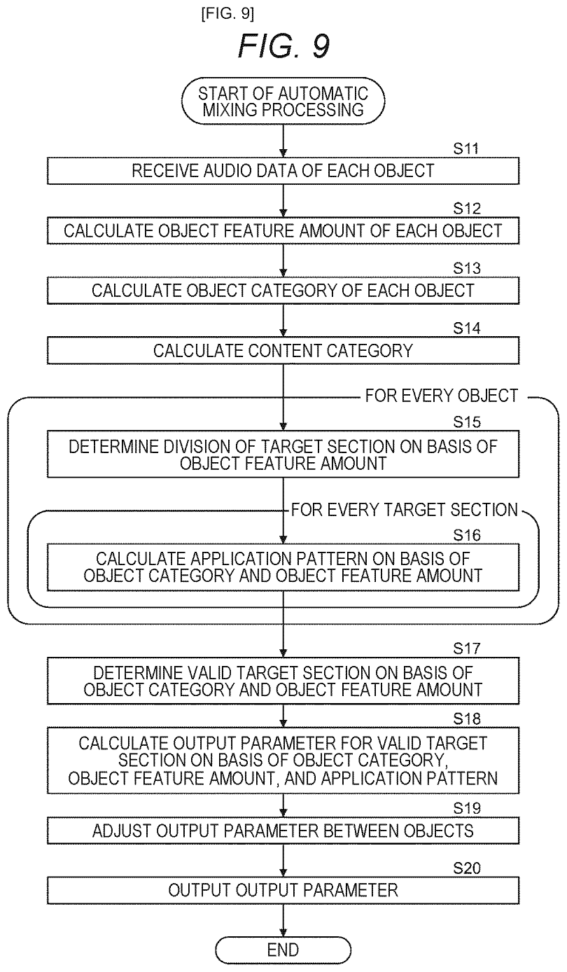

The automatic mixing processing by the automatic mixing apparatus illustrated in FIG. 8 will be described with reference to the flowchart illustrated in FIG. 9.

In step S11, the audio data reception unit 61 receives the audio data of each object of the 3D audio content input to the automatic mixing apparatus, and supplies the audio data to the units from the object feature amount calculation unit 62 to the content category calculation unit 64. For example, the audio data of each object is input from the recording unit 23, the communication unit 24, and the like.

In step S12, the object feature amount calculation unit 62 calculates an object feature amount that is a scalar value indicating the feature of each object on the basis of the audio data of each object supplied from the audio data reception unit 61, and supplies the object feature amount to the application pattern determination unit 65, the output parameter calculation unit 66, and the output parameter adjustment unit 67.

In step S13, the object category calculation unit 63 calculates an object category indicating the type of each object on the basis of the audio data of each object supplied from the audio data reception unit 61, and supplies the object category to the application pattern determination unit 65, the output parameter calculation unit 66, and the output parameter adjustment unit 67.

In step S14, the content category calculation unit 64 calculates a content category indicating the type of music (content) on the basis of the audio data of each object supplied from the audio data reception unit 61, and supplies the content category to the application pattern determination unit 65, the output parameter calculation unit 66, and the output parameter adjustment unit 67.

In step S15, the application pattern determination unit 65 determines the division of the target section for every object on the basis of at least the object feature amount supplied from the object feature amount calculation unit 62.

That is, the application pattern determination unit 65 divides the entire sound reproduction section based on the audio data of the object into a plurality of target sections on the basis of the object feature amount. Each target section may be a section having the same length, or may be a section having different lengths. Furthermore, in the division into the target section, an object category or a content category may be used in addition to the object feature amount.

In step S16, for every object, the application pattern determination unit 65 calculates, as an application pattern, a change pattern to be applied to the target section, on the basis of the object category and the object feature amount for each target section. That is, the application pattern determination unit 65 determines, as the application pattern, one of a plurality of change patterns for every target section. The application pattern is a change pattern, which is determined to be applied to the target section, among the plurality of change patterns.

The application pattern determination unit 65 supplies the determination result of the application pattern for every target section 41 each object to the output parameter calculation unit 66. Thus, the result of division into the target section is also supplied to the application pattern determination unit 65. Note that the content category may also be used to determine the application pattern.

In step S17, the output parameter calculation unit 66 determines a valid target section among the plurality of target sections for every object on the basis of the object category from the object category calculation unit 63 and the object feature amount from the object feature amount calculation unit 62.

Here, the valid target section is a section to which the application pattern is actually applied. Note that the content category may also be used to determine the valid target section.

In step S18, the output parameter calculation unit 66 calculates an output parameter for the valid target section determined in step S17 on the basis of the object category, the object feature amount, and the application pattern, and supplies the output parameter to the output parameter adjustment unit 67. That is, the output parameter is determined for every valid target section.

Therefore, metadata including one or more output parameters that change in time series in the validated target section is obtained for every object.

Note that the output parameter calculation unit 66 calculates an output parameter for a target section that has not been validated (a target section that is invalid) on the basis of at least one of, for example, the content category, the object category, or the object feature amount. In this case, the output parameter is a fixed value that does not change in time series in the target section.

Specifically, for example, the output parameter calculation unit 66 determines, an output parameter calculation function having an object feature amount as an input and an output parameter as an output for every object, on the basis of at least one of the content category, the object category, or the object feature amount. Then, the output parameter calculation unit 66 calculates (determines) an output parameter for every object on the basis of the object feature amount and the output parameter calculation function, and supplies the output parameter to the output parameter adjustment unit 67.

In step S19, the output parameter adjustment unit 67 adjusts the output parameter supplied from the output parameter calculation unit 66 between objects, and supplies, to the output parameter output unit 68, the output parameter of each object after adjustment.

That is, the output parameter adjustment unit 67 adjusts the output parameters of one or more objects on the basis of the output parameters obtained in step S18 for the plurality of objects. For example, in step S19, the output parameters are adjusted according to the positional relationship of the plurality of objects. At this time, the output parameter adjustment unit 67 appropriately adjusts the output parameter by using the object feature amount, the object category, and the content category.

The object feature amount or object category, and the content category are attribute information indicating content or an attribute of an object. Thus, it can be said that the processing performed in the above steps S15 to S19 is processing of determining (calculating) the output parameter constituting the metadata of the object on the basis of one or more pieces of attribute information.

In step S20, the output parameter output unit 68 outputs the output parameter of each object supplied from the output parameter adjustment unit 67, and the automatic mixing processing ends.

As described above, the automatic mixing apparatus, that is, the information processing apparatus 11 calculates the object feature amount, the object category, and the content category, which are the attribute information, and calculates (determines) the output parameter that can change in time series, on the basis of the attribute information.

In this way, it is possible to easily create high-quality 3D audio content in a short time according to the workflow of the mixing engineer in consideration of the features of the object and the entire music. In particular, in the automatic mixing apparatus, the output parameter that changes in time series can be generated, so that it is possible to achieve movement of the object in accordance with the music, and the like, and obtain the 3D audio content with higher quality.

Note that the automatic mixing processing described with reference to FIG. 9 may be performed on music, that is, the entire content (3D audio content), or may be performed on a partial time section of the content for every time section.

### 3.2. Content Category

Hereinafter, processing performed in each unit of the automatic mixing apparatus will be described in more detail.

The “attribute information” used for determining the output parameter is divided into the “content category” indicating the type of music, the “object category” indicating the type of object, and the “object feature amount” which is a scalar value indicating the feature of the object.

The content category is information indicating the type of content, and is expressed (indicated) by, for example, characters and the like that are understandable to the user. Examples of the content category in a case where the content is music include genre, tempo, tonality, feeling, recording type, presence or absence of video, and the like.

The genre is the type of music classified according to the rhythm of the music, the scale to be used, and the like, and the tempo is obtained by classifying the music according to the speed feeling of the music. The tonality indicates the base tone and the scale of the music, and the feeling is obtained by classifying the music according to the atmosphere of the music or the feeling felt by a listener.

The recording type indicates a recording type of audio data such as live or studio, and the presence or absence of a video indicates the presence or absence of video data synchronized with (accompanying) the audio data as content.

Note that the content category may be automatically obtained from the audio data of the object, or may be manually input by the user. In a case where the content category calculation unit 64 automatically obtains the content category, the content category may be estimated from the audio data of the object by a classification model trained using a machine learning technology, or may be determined on the basis of rule-based signal processing.

### 3.3. Object Category

The object category is information indicating the type of the object, and is expressed (indicated) by, for example, characters and the like that are understandable to the user. Examples of the object category include an instrument type, a reverb type, a timbre type, a priority, a role, and the like.

The instrument type indicates the type of the instrument recorded in the audio data of each object, and the reverb type is obtained by roughly dividing the reverb intensity as the object feature amount for every intensity.

The timbre type classifies what effect or feature the timbre of the audio data of each object has, and the priority indicates the importance of the object in the music. For example, the roles are roughly classified into roles of objects in music, such as main vocals and leads.

Note that the object category may be automatically obtained from the audio data of the object, or may be manually input by the user. In a case where the object category calculation unit 63 automatically obtains the object category, the object category may be estimated from the audio data of the object by a classification model trained using a machine learning technology, or may be determined on the basis of rule-based signal processing. Furthermore, in a case where the name of the object, that is, for example, text information indicating the name of the object includes a character string related to the object category, the character string may be extracted as the object category.

### 3.4. Object Feature Amount

The object feature amount is a scalar value indicating the feature of the object. For example, the object feature amount is expressed by a numerical value that is understandable to the user. Examples of the object feature amount include a rise, a duration, a pitch, a note density, a reverb intensity, a sound pressure, a timbre, an interval, a time occupancy, a tempo, a lead index, a degree of excitement, and spread information indicating how widely the object spreads.

The rise is a time from when a certain sound begins until the sound reaches a certain volume, the duration is a time from when the sound rises until the sound reaches a certain volume or less, and the note density is a time-based density of the number of sounds in the audio data.

The reverb intensity indicates the degree of reverberation, and is a feature amount that can be understood as the length of the sound's resonance. The time occupancy rate is a proportion occupied by the time during which the sound is emitted in the time of a sound source, and the lead index is a feature amount indicating the relative importance of the object in the music.

The degree of excitement is a feature amount expressed by a scalar value between 0 and 1 indicating the degree of excitement in the music, and the value of the degree of excitement closer to 1 indicates a higher level of excitement in the music.

The degree of excitement changes in the time direction, and the change in the excitement of the music can be followed by the change in the degree of excitement over time. For example, the degree of excitement is low in a quiet intro (introduction) part, and the degree of excitement is high in a rust part.

For example, the degree of excitement is calculated on the basis of the sound pressure of the audio data. The object feature amount calculation unit 62 counts sections having sound, by using the feature amount of the sound pressure, and determines, as the degree of excitement, the proportion of the number of tracks sounding to the total number of tracks during a predetermined time.

Specifically, the object feature amount calculation unit 62 counts tracks having sound at the predetermined time. As a counting method, in a case where the sound pressure exceeds a predetermined threshold, it is counted that there is sound. The threshold of the sound pressure may be designated by the user or may be a predetermined value. By expressing, as a ratio of m/n, the number of counted tracks m with respect to the total number of tracks n, this value can be used as the feature amount (object feature amount) of the degree of excitement.

Note that, in addition to the method described above, the object feature amount calculation unit 62 may estimate the object feature amount from the audio data by a regression model trained using a machine learning technology, or may extract the object feature amount from the name of the object. Furthermore, the user may manually input the object feature amount.

In addition, the object feature amount may be calculated from the entire audio data, or may be calculated by detecting one sound or one phrase by a known method and aggregating values of feature amounts calculated for each detected sound and each detected phrase by a known method.

In addition, information other than the above-described information may be set as any of the “content category”, the “object category”, or the “object feature amount”. For example, rendering method information indicating which rendering method (for example, vector based amplitude panning (VBAP) or the like) is used to render the object may be set.

Furthermore, information regarding the device used by the user (for example, type information, such as an earphone, a headphone, a hearing aid, a sound collector, and a head mounted display (HMD) (for example, a VR display to be described later), model number information, and the like) and user profile information (for example, normal or hearing loss, and the like, and in the case of hearing loss, results of previous hearing tests and the like) may also be acquired separately. The information regarding the device and the user profile information described above may be separately input by the user from an external device such as a smart phone, or may be acquired from data uploaded to a server the like in advance.

### 3.5. Determination of Pattern Classification Target Section

After the feature amount analysis, that is, the calculation of the object feature amount is completed, the application pattern is determined for every target section of the audio data. That is, the change pattern to be applied for every target section is determined. The determination of the application pattern is performed for all the target sections.

The target section may be manually designated by the user or may be automatically determined.

For example, in a case where the user manually designates each target section, in step S15 of FIG. 9, the application pattern determination unit 65 divides the audio data for every object into a plurality of target sections, on the basis of a signal corresponding to the user operation supplied from the input unit 21. That is, each target section is determined.

On the other hand, in a case where the application pattern determination unit 65 automatically determines the target section, the target section is determined on the basis of the object feature amount.

In such a case, for example, by using machine learning, the application pattern determination unit 65 may detect the phrase of each track on the basis of the input by the user, the sound pressure of the audio data, and the like and may set the section of the phrase as the target section. Furthermore, for example, by using a rule-based algorithm, the application pattern determination unit 65 may set, as one target section, a section in which the sound pressure as the object feature amount is continuously equal to or greater than the threshold.

### 3.6. Determination of Application Pattern

When the entire reproduction section of the audio data is divided into a plurality of target sections, thereafter, the change pattern to be applied to each target section is determined as the application pattern by the application pattern determination unit 65, on the basis of the object feature amount and the like.

Which change pattern is applied to each target section may be based on machine learning or rule, but an example of determining the application pattern based on the rule will be described below.

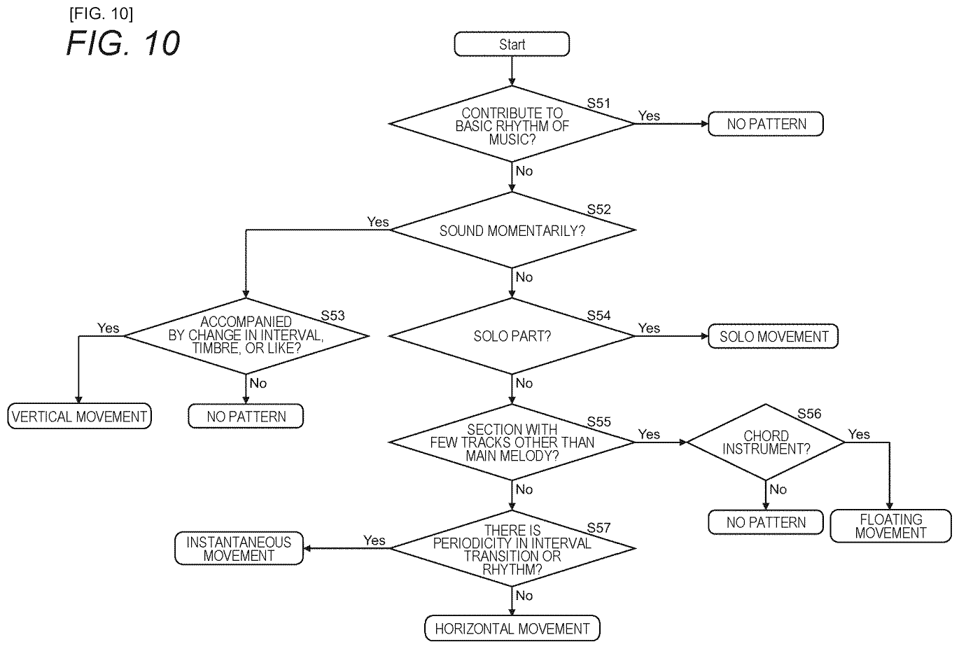

That is, FIG. 10 illustrates a rule of determining an application pattern using a decision tree.

In the application pattern determination unit 65, each target section is subjected to the decision tree illustrated in FIG. 10.

First, in an initial determination S51 of the decision tree, the application pattern determination unit 65 determines whether or not the target section contributes to the basic rhythm configuration of the music.

The determination S51 may be performed on the basis of the instrument type as the object category, or may be performed on the basis of the object feature amount. For example, the target section in which the periodicity of the envelope obtained from the waveform information of the audio data as the object feature amount is short and constant is determined to contribute to the basic rhythm configuration of the music, and can be excluded from the application of the change pattern.

In a case where it is determined in the determination S51 that the target section contributes to the basic rhythm configuration, it is determined that there is no pattern in this target section. That is, it is regarded that the change pattern is not applied to this target section. In other words, it can also be said that the change pattern of “no pattern” is selected (determined) as the application pattern in the target section determined to contribute to the basic rhythm configuration.

For example, similarly to the case of the target section determined to be invalid, in the target section to which the change pattern “no pattern” is applied, the output parameter of the fixed value that does not change in time series is calculated on the basis of at least one of the content category, the object category, or the object feature amount. Thus, “no pattern” can be said to be a change pattern in which the object does not move.

On the other hand, in a case where it is determined in the determination S51 that the applied pattern does not contribute to the basic rhythm configuration, next, in a determination S52, the application pattern determination unit 65 makes a determination based on the time during which sound is emitted. That is, it is determined whether or not the target section is a section in which sound is momentarily emitted.

In the determination S52, for example, the information of the sound pressure as the object feature amount may be used, when the sound pressure is equal to or greater than a predetermined threshold, it may be determined that there is sound, and the time during which the sound is emitted in the target section may be determined. For example, when the time during which the sound is emitted is equal to or less than a predetermined time, it is determined that the target section is a section in which sound is momentarily emitted.

Note that the definition of “momentarily” may be determined as a specific number of seconds by the user, or may be determined based on a parameter that indicates a momentary sounding time provided in a basic setting.

In a case where it is determined in the determination S52 that the target section is a section in which sound is momentarily emitted, the application pattern determination unit 65 performs processing of a determination S53. In the determination S53, it is determined whether or not the target section is a section accompanied by a change in interval or timbre.

For example, in a case where the absolute value of the change amount of the pitch or the sound pressure as the object feature amount in the target section is equal to or greater than a predetermined threshold or in a case where the change rate of the pitch or the sound pressure is equal to or greater than a predetermined threshold, it may be determined that the interval or the timbre in the target section is changed, that is, the target section is a section with a change. Furthermore, the threshold used in the determination S53 may be designated by the user.

In a case where it is determined in the determination S53 that the target section is a section accompanied by a change, the application pattern determination unit 65 sets the application pattern of the target section to “vertical movement”.

On the other hand, in a case where it is determined in the determination S53 that the target section is a section with no change, the application pattern determination unit 65 sets the application pattern of the target section to “no pattern”.

Furthermore, in a case where it is determined in the determination S52 that the target section is not a target section in which sound is momentarily emitted, the application pattern determination unit 65 performs processing of a determination S54. In the determination S54, it is determined whether or not the target section is a section of a solo part.

For example, the determination S54 may be performed by comparing the sound pressure as the object feature amount in the target section with the sound pressure in the same section as the target section in another track different from the track to which an object in the target section to be processed belongs. In such a case, when the sound pressure of the target section is larger than the sound pressure of the another track by a predetermined threshold or more, it may be determined that the target section is a section of a solo part.

In a case where it is determined in the determination S54 that the target section is a section of a solo part, the application pattern determination unit 65 sets the application pattern of the target section to “solo movement”.

In a case where it is determined in the determination S54 that the target section is not a section of a solo part, the application pattern determination unit 65 performs processing of a determination S55. In the determination S55, information of other tracks at the time of the target section is referred to, and it is determined whether or not the number of tracks at the time is equal to or greater than a threshold. That is, it is determined whether or not the section is a section with few tracks other than the main melody.

Note that, in the determination S55, instead of an absolute numerical value such as the number of tracks, an index, which indicates the relative proportion of tracks that are sounding, such as the degree of excitement as the object feature amount may be used.

By such determination S55, it is determined whether or not the section corresponding to the target section in the entire content is a quiet section (calm section).

In a case where it is determined in determination S55 that the section is a calm section, that is, a section with few tracks other than the main melody, the application pattern determination unit 65 performs processing of a determination S56. In the determination S56, it is determined whether or not the target section is a section of sound of a chord-playing instrument (chord instrument).

In the determination S56, the instrument type as the object category or the object feature amount regarding the instrument type may be used, or the pitch of the sound as the object feature amount may be used.

In a case where it is determined in the determination S56 that the target section is a section of the chord-playing instrument, the application pattern determination unit 65 sets the application pattern of the target section to “floating movement”.

On the other hand, in a case where it is determined in the determination S56 that the target section is not a section of the chord-playing instrument, the application pattern determination unit 65 sets the application pattern of the target section to “no pattern”.

Furthermore, in a case where it is determined in the determination S55 that the section is not a calm section, that is, the section is not a section with few tracks other than the main melody, the application pattern determination unit 65 performs processing of the determination S57.

In the determination S57, it is determined whether or not the target section has periodicity in the object feature amount, which changes with time, such as interval transition or rhythm. In this determination S57, for example, the interval, the waveform information of the audio data, and the like as the object feature amount are used. Furthermore, the determination S57 may be performed by a method of calculating autocorrelation for each object feature amount.

In a case where it is determined in the determination S57 that the object feature amount has periodicity, that is, that the interval transition or the rhythm has periodicity, the application pattern determination unit 65 sets the application pattern of the target section to the “instantaneous movement”.

On the other hand, in a case where it is determined in the determination S57 that the object feature amount has no periodicity, the application pattern determination unit 65 sets the application pattern of the target section to the “horizontal movement”.

As described above, the application pattern determination unit 65 determines the change pattern (application pattern) to be applied to each target section for every object, on the basis of the held decision tree, the object feature amount, and the like. In other words, each target section is associated with the change pattern.

A specific example of the sound and the change pattern associated by the decision tree illustrated in FIG. 10 is illustrated.

For example, the change pattern “vertical movement” is associated with a sound, which has many noise components and a volume change, such as NoiseSweep, a sound, which has a constant sound pressure and a descending interval, such as BassSweepDown, a sound, which is obtained by reversely reproducing a sampled cymbal sound, such as a reverse cymbal, and the like.

Furthermore, for example, the change pattern “horizontal movement” is associated with sound and the like of a chord instrument such as an impressive synthesizer in an A-melo (A melody) and a B-melo (B melody).

The change pattern “floating movement” is associated with, for example, the sound of an acoustic instrument such as a violin used in the A-melo, and the sound of a chord instrument having a role of filling a space.

The change pattern “instantaneous movement” is associated with, for example, a guitar that performs a certain refrain. The change pattern “solo movement” is associated with, for example, the sound of a piano, a guitar, a synthesizer, or the like that plays a solo part.

Furthermore, instead of determining Yes or No as in the decision tree described above, the application pattern may be determined from the content category, the object category, and the object feature amount by using a predetermined conversion function.

In such a case, for example, the content category, the object category, and the object feature amount are converted into scalar values by the predetermined conversion function. Then, the value obtained by the conversion is subjected to the weighted addition, and whether or not to apply the change pattern, that is, whether or not to use the change pattern as the application pattern is determined on the basis of the value obtained as a result of the weighted addition.

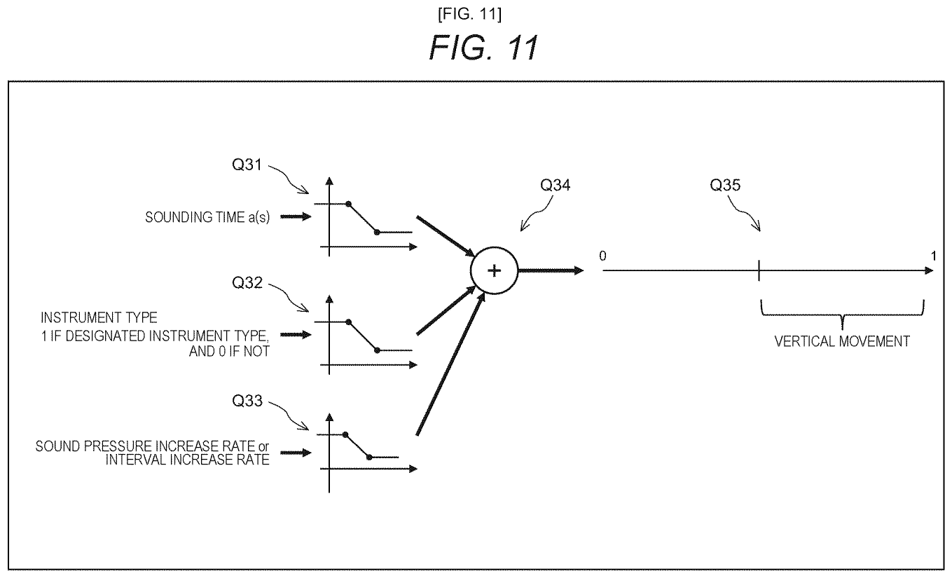

FIG. 11 illustrates a specific example when it is determined whether or not the change pattern “vertical movement” is used as the application pattern.

In the example illustrated in FIG. 11, three elements of a “time a(s) during which sound is emitted”, an “instrument type”, and a “sound pressure increase rate or interval increase rate” are used to determine whether “vertical movement” are used as the application pattern.

For example, the application pattern determination unit 65 calculates the “time a(s) during which sound is emitted” on the basis of the sound pressure or the like as the object feature amount, and uses the time a(s) as an input of the conversion function indicated by an arrow Q31.

Furthermore, the “instrument type” is an instrument type as the object category. For example, the application pattern determination unit 65 inputs a numerical value “1” to the conversion function indicated by an arrow Q32 when the instrument type as the object category indicates a predetermined designated instrument, and inputs a numerical value “0” to the conversion function indicated by the arrow Q32 when the instrument type does not indicate the predetermined designated instrument.

Moreover, for example, the application pattern determination unit 65 calculates the “sound pressure increase rate or interval increase rate” on the basis of the sound pressure, the interval, or the like as the object feature amount, and uses the obtained sound pressure increase rate or interval increase rate as an input of the conversion function indicated by an arrow Q33.

The conversion function is illustrated in each portion of the arrows Q31 to Q33. More specifically, a graph of the conversion function is illustrated in which a horizontal axis is an input of the conversion function and a vertical axis is an output of the conversion function.

These points on the graph are conversion parameters determined in advance or designated (changed) by the user. For example, the user can designate (change) the positions in the vertical axis direction and the horizontal axis direction of the conversion parameters on each graph, the number of conversion parameters, and the like by operating the input unit 21 in a state where a screen similar to that in FIG. 11 is displayed on the display unit 22.

The maximum value of the output value of the conversion function, in other words, the weight (contribution degree) of each element also changes according to such a conversion parameter.

The application pattern determination unit 65 inputs the “time a(s) during which sound is emitted” to the conversion function indicated by the arrow Q31 and calculates the output value of the conversion function.

Similarly, the application pattern determination unit 65 inputs the value obtained from the “instrument type” to the conversion function indicated by the arrow Q32 to calculate the output value of the conversion function, and inputs the “sound pressure increase rate or interval increase rate” to the conversion function indicated by the arrow Q33 to calculate the output value of the conversion function. These output values are scalar values.

Further, as indicated by an arrow Q34, the application pattern determination unit 65 adds the output values of the three conversion functions to obtain a predetermined composite value. For example, the composite value is set to a scalar value between 0 and 1. That is, the conversion parameter and the contribution degree of each conversion function are determined such that the composite value is a value between 0 and 1.

As indicated by an arrow Q35, the application pattern determination unit 65 compares the obtained composite value with a predetermined threshold to determine whether or not to set the application pattern of the target section to the “vertical movement”. In this example, when the composite value is equal to or larger than the threshold, the “vertical movement” is set as the application pattern of the target section.

In the example of FIG. 11 as described above, for example, when the user determines that it is important to determine whether sound is momentarily emitted, the contribution degree of the element can be changed by changing the conversion parameter of the conversion function indicated by the arrow Q31 and increasing the value of the weight of the element of the “time a(s) during which sound is emitted”, that is, the maximum value of the output value of the conversion function.

The object feature amount, the object category, and the content category are used to determine the application parameter by the decision tree or the conversion function described above.

Since the object feature amount, the object category, and the content category are expressed by characters, numerical values, or the like that are understandable to the user, the user can also understand an algorithm for determining the application pattern based on a decision tree, a conversion function, or the like.

In this regard, for example, a display screen related to the algorithm based on the decision tree illustrated in FIG. 10, the conversion function illustrated in FIG. 11, or the like may be displayed on the display unit 22 so that the user can edit (change) the decision tree, the conversion parameter of the conversion function, or the like.

For example, it is assumed that the decision tree illustrated in FIG. 10 is displayed on the display unit 22. At this time, in a case where it is considered that the determination S51 as to whether or not the user contributes to the basic rhythm of the music is unnecessary, the user can remove the determination S51 in the decision tree and create a new decision tree by operating the input unit 21.

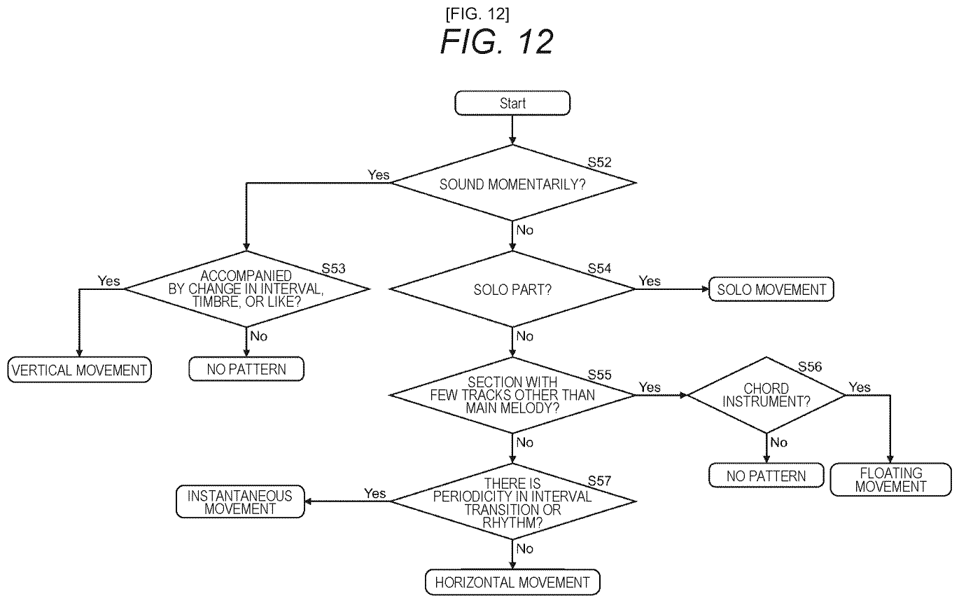

In such a case, the control unit 26 newly generates the decision tree illustrated in FIG. 12, for example, on the basis of the signal supplied from the input unit 21, and supplies the generated decision tree to the application pattern determination unit 65 to hold. Note that, in FIG. 12, portions corresponding to those in the case of FIG. 10 are denoted by the same reference numerals, and the description thereof will be omitted.

The decision tree illustrated in FIG. 12 is obtained by erasing the determination S51 of the decision tree illustrated in FIG. 10, and the decision tree illustrated in FIG. 12 is used as the decision tree obtained by the change (editing) and is subsequently used in processing in step S16 in FIG. 9.

Note that, in editing the decision tree, for example, the user can change the order of each determination in the decision tree or add a new rule (decision) or a new change pattern to the decision tree. Furthermore, it is also possible to create a desired decision tree by selecting desired presets (determinations) from among those prepared in advance and combining arbitrary determinations and the like. Therefore, a decision tree optimized for each user can be easily constructed.

### 3.7. Determination of Movement Section

In all the target sections, the determined application pattern may be applied to move the object, that is, generate the output parameter that changes in time series, but the number of target sections in which the object is moved may be adjusted. That is, by performing the processing in step S17 in FIG. 9, a predetermined number of target sections among all the target sections may be set as valid target sections, and the application pattern may be applied to the valid target sections.

As a method of adjusting the number of target sections, for example, a scalar value indicating the likelihood of a moving object may be calculated, and adjustment may be performed on the basis of the scalar value. A method of calculating the scalar value may be different for every change pattern, and for example, the number of movement sections, that is, the number of valid target sections can be calculated by following procedures STP1 to STP3. Each processing of these procedures STP1 to STP3 is performed by the output parameter calculation unit 66.

### Procedure STP1

Select one or more object feature amounts to be used for calculation of a scalar value.

### Procedure STP2

Combine the one or more object feature amounts selected in procedure STP1 into one scalar value (procedure STP3).

When the scalar value calculated in procedure STP2 is equal to or greater than a threshold, a movement section (valid target section) is set.

In the calculation of the combination in procedure STP2, for example, a plurality of object feature amounts may be combined (aggregated) into one scalar value by an arbitrary known method.

Furthermore, the scalar value calculated in procedure STP2 may be obtained by performing conversion from a plurality of object feature amounts to one scalar value for every change pattern by a method similar to the method described with reference to FIG. 11.

Moreover, the number of movement sections, that is, the number of validated target sections (the number of adopted sections) may change with the temporal change of the music.

For example, in a place where the change rate of the degree of excitement as the object feature amount is large, more moving objects may be adopted (more target sections are validated), and when the change rate of the degree of excitement is 0 or less, the moving objects may not be adopted (there is no validated target section). In this case, when the change rate of the degree of excitement is large at a predetermined time in the reproduction section of the content, more objects are set as the moving objects at that time. That is, the target sections of more objects are regarded to be valid target sections.

### 3.8. Determination of Movement Method Based on Each Change Pattern in Movement Section

When the section for moving the object, that is, the valid target section is determined, thereafter, output is performed in which the application pattern associated with the valid target section is applied. That is, for the valid target section, the output parameter is calculated (generated) on the basis of the application pattern defined for the target section.

In the generation of the output parameter, fixed output may be performed in each change pattern, that is, a fixed output parameter may be generated, or the output parameter may be changed depending on the object feature amount and the like even in the same change pattern.

Here, an example of generation of an output parameter in the target section (movement section) associated with the change pattern “vertical movement” will be described.

For example, the moving direction of the moving object in the change pattern “vertical movement”, that is, the moving direction of the three-dimensional position of the moving object is determined by the change in the sound pressure or the interval as the object feature amount.

In this case, the output parameter calculation unit 66 calculates the change rate of the sound pressure or the interval as the object feature amount, and when the change rate is equal to or greater than a predetermined threshold, the direction in which the moving object is moved from the bottom to the top in the space is set as the moving direction. On the other hand, when the change rate is less than the predetermined threshold, the output parameter calculation unit 66 sets, as the moving direction, the direction in which the moving object is moved from the top to the bottom in the space.

Furthermore, the timings of the start and end of the movement of the moving object are the timings of the start and end of the target section. Thus, the moving object starts moving in the moving direction at the start of the target section, and ends moving at the end of the target section. That is, the moving object moves up and down (moving direction) by using the entire time from the start to the end of the target section.

The output parameter calculation unit 66 calculates, as the output parameter that changes in time series, the elevation at each time at which the moving object is moved in the moving direction in this manner.

Note that, as the moving range of the moving object, for example, a basic range is determined in advance, and the moving object moves within the basic range. That is, the amount by which the elevation as the output parameter changes is set to an amount corresponding to the basic range. This basic range may be designated by the user operating the input unit 21.

Furthermore, in the change pattern “vertical movement”, the output parameter calculation unit 66 may calculate the azimuth as the output parameter, on the basis of at least one of the content category, the object category, or the object feature amount. In this case, the azimuth in the target section is a fixed value that does not change in time series.

Note that, as described above, in the change pattern “vertical movement”, in addition to the time-series change in the elevation in the target section, that is, the movement of the moving object in the up-down direction, the time-series change (temporal change) may also be applied to the azimuth.

In such a case, for example, the output parameter calculation unit 66 calculates the moving speed in the movement of the moving object in the up-down direction due to the change in the elevation. Then, in a case where the obtained moving speed is equal to or less than a predetermined threshold, the output parameter calculation unit 66 determines the moving amount of the azimuth as the output parameter such that the moving speed of the moving object, that is, the moving speed in consideration of the movement in the up-down direction and the left-right direction becomes the threshold.

By doing so, the moving speed of the moving object in the up-down direction is equal to or less than the predetermined threshold, but the moving speed of the moving object becomes the same speed as the threshold. In this case, for example, a value obtained by adding the moving amount of the above-described azimuth to the azimuth corresponding to the movement start point of the moving object is set as the value of the azimuth at the movement end point of the moving object.

The movement method of the moving object in each change pattern may be a movement method determined by a method different from the vertical movement described above.

Here, a specific example of the movement method of the moving object in each change pattern, that is, a specific example of the output parameter that changes in time series will be described.

For example, in the “vertical movement”, in a case where the change amount of the object feature amount such as the interval or the sound pressure is large, it is conceivable to add the change amount of the azimuth to the azimuth as the output parameter according to the change amount.

Furthermore, for example, there is a case where the object to be moved is a plurality of pairs of stereo pairs or more, that is, a case where a plurality of objects belonging to the same track is set as the moving object.

In such a case, in the “horizontal movement”, when a correlated feature amount between the objects (channels), that is, a correlation in the object feature amount is low, the output parameter is determined such that each object moves horizontally in a state where a gap between the plurality of objects is narrow. Conversely, when the correlated feature amount is high, the output parameter is determined such that each object moves horizontally in a state where the gap between the plurality of objects is wide.

Furthermore, for example, in the “horizontal movement”, the rotation period of the moving object, that is, the period of the temporal change of the azimuth as the output parameter is determined such that the rotation period of the moving object is a constant multiple of the tempo of the music or the period of the phrase.

For example, in the “floating movement”, the output parameter of the moving object is determined such that a constant multiple of the transition period of the timbre change becomes the movement period of the moving object, on the basis of the transition period of the change of the timbre as the object feature amount or the tempo as the object feature amount. The output parameter here is the azimuth or the elevation of the moving object.

Furthermore, for example, in a case where the time of one period of the transition period described above is short, the moving range of the moving object is made small (narrow), and in a case where the time of one period is long, the moving range of the moving object is made large (wide).

### 3.9. Adjustment of Movement Method

After the “3.6. Determination of Application Pattern”, the metadata (output parameter) may be adjusted between the objects according to the positional relationship or the like of the plurality of objects.

For example, in step S19 in FIG. 9 described above, the output parameter is adjusted between a plurality of objects, and adjustment for avoiding masking between objects and the like can be considered as an example of such adjustment.

For example, based on the output parameter of the object obtained in step S18 of FIG. 9, a case is considered in which another object is present near the route of the movement of a predetermined object, and the sound of these objects is present at the same time (sound is emitted).

That is, a case is considered in which a distance between the two objects is equal to or less than a predetermined threshold at a predetermined time, and the sound pressure of the audio data of each of the two objects at the predetermined time is equal to or greater than a predetermined threshold.

In such a case, the sounds of the respective objects may mask each other, and the motion (movement) of the sound of each object may be audibly difficult to perceive (difficult to recognize).

In this regard, for example, in the above-described case, the movement route of the moving object is changed such that the distance between the objects is increased, that is, a distance between the objects becomes larger than the threshold. That is, for example, the output parameters constituting the three-dimensional position of the moving object, such as the azimuth and the elevation, are changed (adjusted). Note that the output parameters may be changed not only for the moving object but also for an object that is not moving.

By performing such adjustment of the output parameter, masking of the sound of each object is eliminated (occurrence of masking is suppressed), and the effect of the reproduction sound generated by the movement of the object can be maximized.

Note that the adjustment of the output parameter, that is, the adjustment of the position of the object may be performed for all the moving objects of the content, may be performed only for some moving objects satisfying a specific condition, or may be adjusted by the user. Furthermore, the three-dimensional position of the moving object may be prioritized, and the position of the object without motion may be changed.

### 3.10. Adjustment of Movement Method by GUI

By the way, in the information processing apparatus 11, in order to cope with individual differences in the way of thinking between mixing engineers, an algorithm for determining the application parameter or generating the output parameter can be adjusted by a parameter that is understandable to the user.

That is, the algorithm for determining the output parameter on the basis of the object feature amount or the like can be edited by the user. Furthermore, the change pattern itself can also be edited by the user, and the user can edit (change) an existing change pattern, add a new change pattern, or delete a change pattern for a plurality of change patterns that are candidates for the application pattern.

For example, it is also a feature of the present technology that it is possible to provide a user interface that presents parameters regarding the algorithm to the user and allows the user to select parameters from among the candidates or adjust the parameters. In this case, the user interface (UI) may be anything such as the following example as long as parameters can be adjusted.

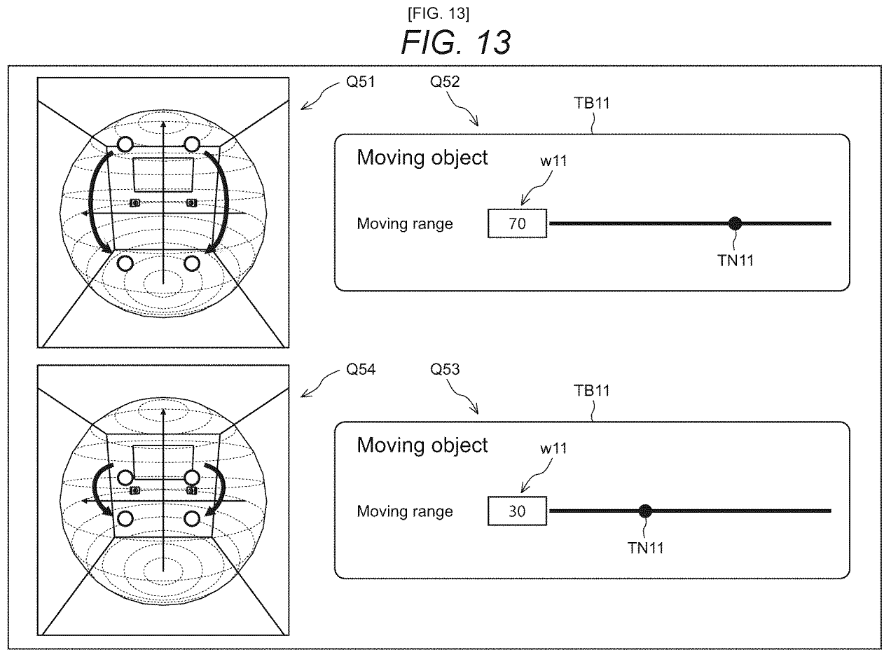

FIG. 13 illustrates a UI example for adjusting the parameter of the moving range of the object in the change pattern “vertical movement”.

In this example, the control unit 26 causes the display unit 22 to display, as a UI, a display screen including, for example, an image of the three-dimensional space indicated by an arrow Q51 and a tab TB11 indicated by an arrow Q52.

In the portion indicated by the arrow Q51, a virtual three-dimensional space in which the object is arranged and the size of the moving range of the moving object are displayed. In particular, a circle on the space indicates the position of the moving object, and an arrow between two circles indicates the moving range of the moving object in the up-down direction.

Furthermore, in the tab TB11, parameter adjustment of the moving range of the object is possible, and in this example, an adjustable item (adjustment item) and a parameter value of the adjustment item are displayed on the tab TB11.

Specifically, an item “moving range” indicating the size of the moving range of the moving object is displayed as the adjustment item on the tab TB11, and a numerical value “70” indicating the size of the moving range, which is the adjustment item, is displayed as the parameter value in the portion indicated by an arrow W11.

Furthermore, an adjustment bar for adjusting the parameter value is provided on the right side of the adjustment item, and the user can operate the input unit 21 to move a knob TN11 on the adjustment bar to the left and right and adjust the size of the moving range as the adjustment item.

For example, it is assumed that the user feels that the moving range of the moving object is excessively wide when using the algorithm for automatically generating the output parameter.

In such a case, as indicated by an arrow Q53, the user can decrease the parameter value indicating the size of the moving range by adjusting knob TN11 of the adjustment bar of the adjustment item “moving range” in the left direction. In this example, the parameter value is adjusted from “70” to “30”, and the moving range of the moving object can be narrowed (reduced) by such adjustment.

Therefore, the image of the portion indicated by an arrow Q51 is changed according to the adjustment of the parameter value and becomes as indicated by an arrow Q54. In the example indicated by the arrow Q54, it is possible to visually confirm that the size of the moving range of the moving object in the up-down direction is narrowed.

The control unit 26 supplies, to the output parameter calculation unit, the parameter value indicating the size of the moving range after adjustment and causes the output parameter calculation unit 66 to hold the parameter value. Therefore, in step S18 in FIG. 9 to be performed thereafter, the output parameter calculation unit 66 calculates the output parameter in the change pattern “vertical movement” by using the adjusted (changed) parameter value “30”.

Note that the adjustment of the parameter value of each adjustment item may be visually performed by the adjustment bar, or the adjustment may be performed by directly inputting a numerical value to the portion indicated by the arrow W11.

Furthermore, the adjustment of the parameter related to the algorithm for calculating (generating) the output parameter from the object feature amount and the like based on the application pattern is not limited to the example illustrated in FIG. 13, and any UI may be used as long as the UI is capable of realizing an equivalent function.

Moreover, the motion of the object in each change pattern applied in “3.8. Determination of Movement Method Based on Each Change Pattern in Movement Section” may be largely edited by the user.

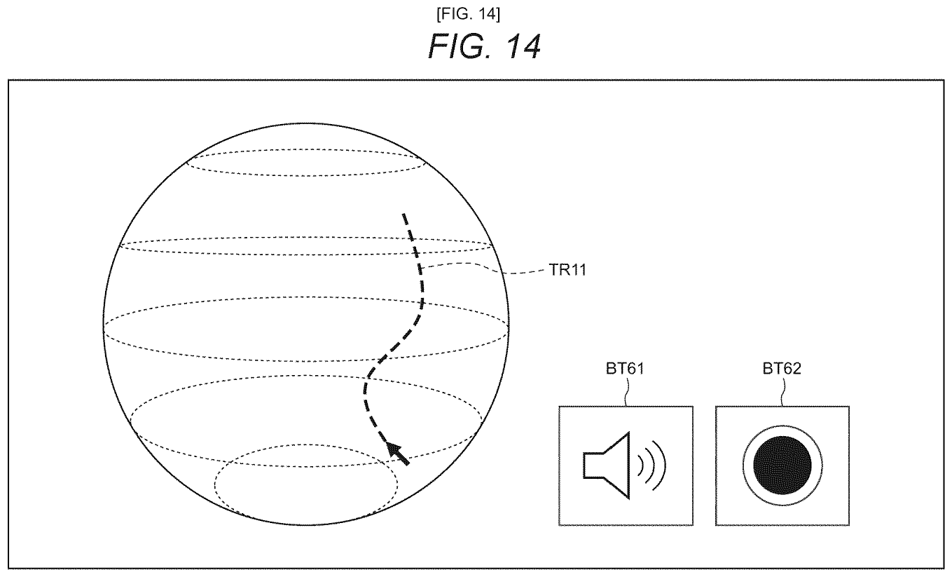

FIG. 14 illustrates an example of a GUI for editing the manner of motion (movement) of the object in the change pattern “vertical movement”.

For example, the control unit 26 causes the display unit 22 to display a display screen (GUI) illustrated in FIG. 14. In this example, a reproduction button BT61 and a recording button BT62 are provided on the display screen.

The user can consider the movement method of the object while listening to the representative sound used for the change pattern to be applied. That is, the user operates the input unit 21 to press the reproduction button BT61, so that the user can listen to the representative sound of the object determined for the “vertical movement”. The control unit 26 controls the sound output unit 25 according to the signal from the input unit 21 to reproduce the representative sound.

When the user wants to record the motion (movement) of the object, the user can shift to a recording mode by operating the input unit 21 to press the recording button BT62.

In the recording mode, the reproduction countdown of the representative sound starts, and the reproduction of the representative sound and the recording of the motion simultaneously start from the moment when the count becomes 0. The user operates the input unit 21 in accordance with the representative sound to be reproduced, and traces the trajectory of the motion by using a pointer device such as a mouse on a display (display screen) on which the 3D space is drawn. In this example, a trajectory indicated by a curve TR11 is input as the trajectory of the motion (movement) of the object.

When the reproduction of the representative sound ends, the output parameter calculation unit 66 records the trajectory traced by the pointer device as the time-series change of the output parameter according to the control of the control unit 26, and sets the trajectory as the manner of moving the object in the change pattern “vertical movement”.

Thus, when the change pattern “vertical movement” is applied to generate the output parameter of the object, the output parameter calculation unit 66 generates the output parameter such that the moving object moves along the trajectory indicated by the curve TR11.

Furthermore, a virtual reality (VR) headset may be used instead of a display for recording the motion of the moving object.

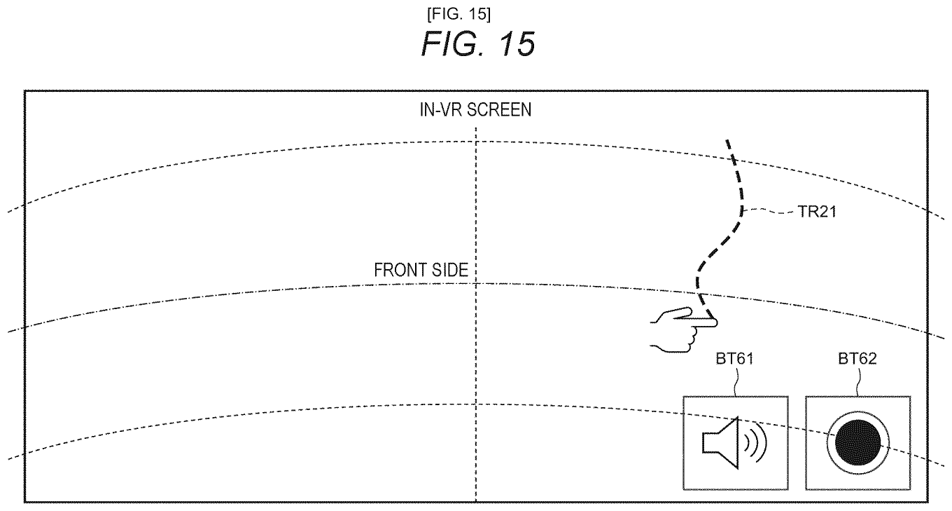

It is assumed that the information processing apparatus 11 is a VR headset. In such a case, for example, as illustrated in FIG. 15, the space in which the object is arranged is displayed on the display unit 22 by VR, the user moves his/her hand with the pointer device described above, and the motion of the object is recorded using the body (hand) of the user. Note that, in FIG. 15, portions corresponding to those in the case of FIG. 14 are denoted by the same reference numerals, and the description thereof will be omitted.

Also in the example of FIG. 15, similarly to the example of FIG. 14, the representative sound is reproduced by the reproduction button BT61, the mode is shifted to the recording mode by the recording button BT62, and the motion of the moving object is recorded. In this example, when the user moves the hand, the trajectory indicated by a curve TR21 is recorded as the trajectory of the motion of the moving object.

Note that the generation and editing of the change pattern by the GUI illustrated in FIGS. 14 and 15 may be used for pattern application by the GUI described in “4. Pattern Application by GUI Operation” described later, and the representative sound may be designated by the user.

### 3.11. Utilization of Video Information

When the application pattern according to the above-described algorithm is applied to the target section in the output parameter calculation unit 66, not only the feature amount of the content such as the object feature amount but also the video information accompanying the content may be used.

Specifically, for example, the analysis result of the video information may be used as one of the rules of the decision tree, and the production by a creator may be supported by utilizing the video information in the content production also using the video.

### 4. Pattern Application by GUI Operation

Hereinafter, an example in which a change pattern is applied by a GUI operation to assist manual production will be described.

### 4.1. Insertion of Pattern

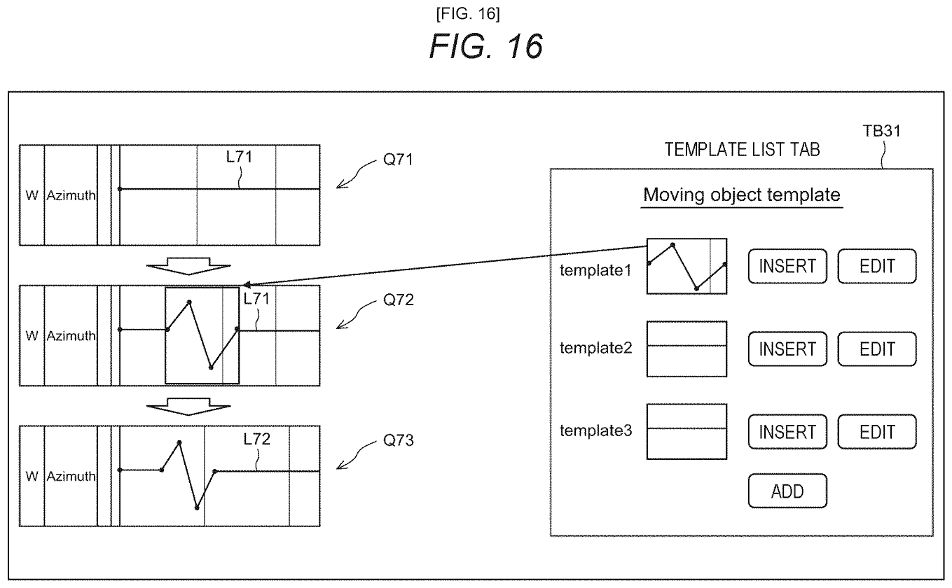

An example in which the user applies (inserts) the change pattern designated by the user to an arbitrary section in the audio data of the object will be described with reference to FIGS. 16 to 20. Note that, in FIGS. 16 to 20, portions corresponding to each other are denoted by the same reference numerals, and the description thereof will be omitted as appropriate.

FIG. 16 illustrates an insertion example of the change pattern.

In this example, the control unit 26 controls the display unit 22 to display a display screen indicated by an arrow Q71 in FIG. 16 on the display unit 22.

In the portion indicated by the arrow Q71, a graph L71 indicating the azimuth of the object at each time is illustrated as a time-series output parameter of the predetermined object. That is, the timeline of the azimuth is displayed.

The user can provide a change point, which is a position (point) where the azimuth changes, on the graph L71 by operating the input unit 21.

In the case of editing (changing) the graph L71 of the azimuth as the output parameter, the user causes a template list tab TB31 illustrated on the right side in the drawing to be displayed on the display unit 22 and performs an operation on the template list tab TB31, so that a change point can be provided on the graph L71.

For example, a list of change patterns registered in advance and used as templates is displayed on the template list tab TB31. That is, on the template list tab TB31, a name of a change pattern such as “template 1”, a graph (change pattern) indicating a time-series change in the output parameter when the change pattern is applied, an insertion button, an edit button, and the like are arranged and displayed for every change pattern.

Note that the change pattern displayed on the template list tab TB31 may be any one such as a pattern indicating a temporal change of one output parameter such as the azimuth among patterns corresponding to the motion of the moving object such as the above-described “vertical movement” or a pattern indicating a representative temporal change of one output parameter.

In a case where the user applies the change pattern to the graph L71 of the output parameter, that is, a case where the user changes a partial section of the graph L71 in a manner similar to the change of the output parameter in a desired change pattern, the user selects the desired change pattern from the template list tab TB31.

Then, the user operates the input unit 21 as indicated by an arrow Q72 to drag and drop and paste the graph (change pattern) of the change pattern selected by the template list tab TB31 to the portion of the section to be changed on the graph L71 (timeline). Note that pasting may be performed by an operation other than drag-and-drop.

Therefore, the information on the change point stored as each change pattern can be pasted to a desired section on the graph L71.

When the graph of the change pattern is pasted, the graph L71 of the azimuth changes as indicated by an arrow Q73, for example. In the example indicated by the arrow Q73, a graph L72 indicates the shape of the graph L71 after the change.

In the graph L72, a plurality of change points is collectively added to a desired section, and the shape of a partial section of the graph L72 is the same as the shape of the graph in the selected change pattern by the addition of these change points.

In general, as described with reference to FIG. 1, the user needs to designate change points one by one and deform the graph shape of the output parameter while adjusting the position of each change point.

On the other hand, in the example of FIG. 16, it is only necessary to paste the graph of the designated change pattern and change the shape of the graph of the output parameter on the GUI. In this case, pasting can be performed in a state where a plurality of change points is edited collectively. As described above, in the example of FIG. 16, the user can easily perform editing and the like of the output parameter in a short time.

In a state where the screen illustrated in FIG. 16 is displayed on the display unit 22, when the input unit 21 is operated by the user and an editing operation such as pasting of a graph of a change pattern to a graph of an azimuth as an output parameter is performed, a signal corresponding to the editing operation is supplied from the input unit 21 to the output parameter calculation unit 66 (control unit 26).

The operation of the user pasting the graph of the change pattern to a specific section of the graph of the azimuth can be said to be an operation of designating (selecting), from among a plurality of change patterns, the change pattern to be applied to the specific section of the entire reproduction section based on the audio data of the object.

The output parameter calculation unit 66 uses the change pattern pasted by the user as the application pattern according to the signal from the input unit 21, determines (generates) the output parameter of the object on the basis of the application pattern, and supplies the output parameter to the output parameter adjustment unit 67. For example, in the example of FIG. 16, the azimuth at each time illustrated in the graph L72 is generated as the output parameter that changes in time series. Note that, in determining the output parameter, not only the change pattern designated (pasted) by the user but also the object feature amount and the like may be used.

Note that, although the azimuth has been described as an example of the output parameter here, it is also possible to edit the elevation, the radius, and the gain in a similar manner.

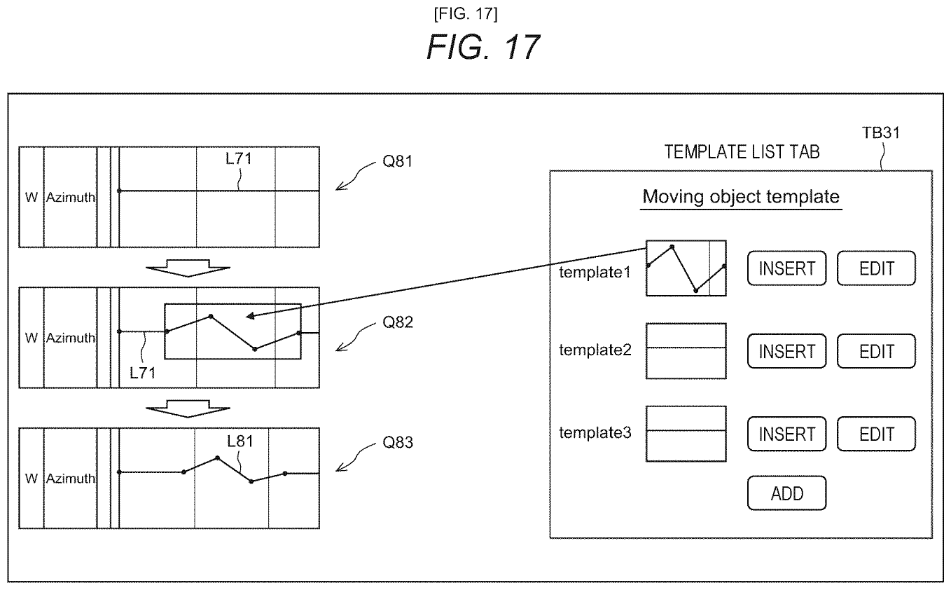

Furthermore, for example, as illustrated in FIG. 17, pasting can be performed with the portion of the graph of the change pattern shorter in the vertical direction than in the case of FIG. 16.

In the example of FIG. 17, for example, the graph of the change pattern is pasted to the graph L71 of the azimuth indicated by an arrow Q81 as indicated by an arrow Q82.

At this time, the length of the graph of the change pattern in the vertical direction is adjusted to be short, whereby the pasting is performed in a state in which the change amount of the azimuth is also reduced (small). That is, the amount of change in azimuth associated with pasting is also reduced (small) in accordance with the length in the vertical direction of the graph of the change pattern.

By such pasting, the graph of the azimuth changes as indicated by an arrow Q83. A graph L81 of the azimuth after the change is illustrated in a portion indicated by the arrow Q83. It can be seen that the change amount of the azimuth in the graph L81 is reduced (smaller) compared to the change amount of the azimuth in the graph L72 indicated by the arrow Q73 in FIG. 16.

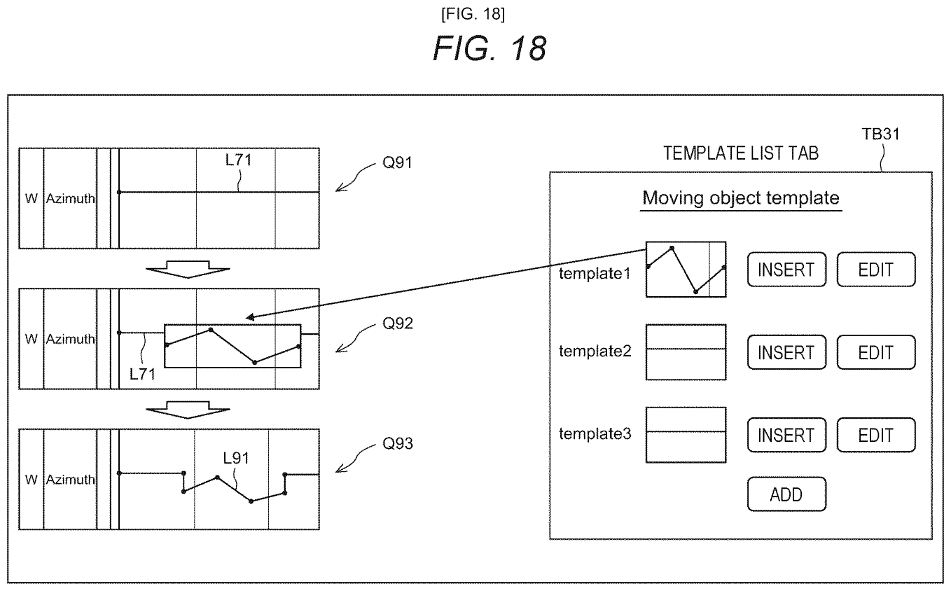

Similarly, for example, as illustrated in FIG. 18, the pasting can be also performed with the portion of the graph of the change pattern longer in a lateral direction than in the case of FIG. 16.

In the example of FIG. 18, for example, the graph of the change pattern is pasted to the graph L71 of the azimuth indicated by an arrow Q91 as indicated by an arrow Q92.

At this time, the length of the graph of the change pattern in the lateral direction is adjusted to be long, whereby the section in which the azimuth changes is also long, and the pasting is performed in a state in which the amount of change in azimuth per unit time is reduced (small). That is, in accordance with the length in the lateral direction of the graph of the change pattern, the section in which the azimuth changes with the pasting also changes, and the amount of change in azimuth per unit time also decreases.

By such pasting, the graph of the azimuth changes as indicated by an arrow Q93. A graph L91 of the azimuth after the change is illustrated in a portion indicated by the arrow Q93.

Furthermore, in the example of FIG. 18, the pasting position in the vertical direction of the graph of the change pattern is shifted downward in the drawing as compared with the example illustrated in FIG. 17. That is, the graph of the change pattern is pasted in a state where the change point is shifted downward.

Therefore, in the graph L91 of the azimuth after the change, it can be seen that the value of the change point is entirely shifted downward (the side where the value decreases).

As described above, in the step of pasting the graph of the change pattern, the graph (pattern) to be pasted can be developed by adjusting the length in the vertical direction or the lateral direction of the graph to be pasted by the user or shifting the pasting position in the up-down direction or the left-right direction. This enables general-purpose editing (change) of the output parameter.

Moreover, for the registered change pattern displayed on the template list tab TB31, information regarding how to connect with the change points before and after the output parameter is also stored.

For example, there are a “pasting destination priority mode”, a “pasting priority mode”, and an “interpolation mode” as modes indicating how to connect (connection methods).

For example, in the pasting destination priority mode, as indicated by the arrow Q93 in FIG. 18, the output parameter (metadata) before pasting is held up to the added change point, and pasting has an influence only on the pasting range of the graph of the change pattern.

That is, in this example, in the section to which the graph of the change pattern is not pasted, the value of the output parameter of the section is used as it is, and the value of the output parameter changes only in the section to which the graph of the change pattern is pasted.

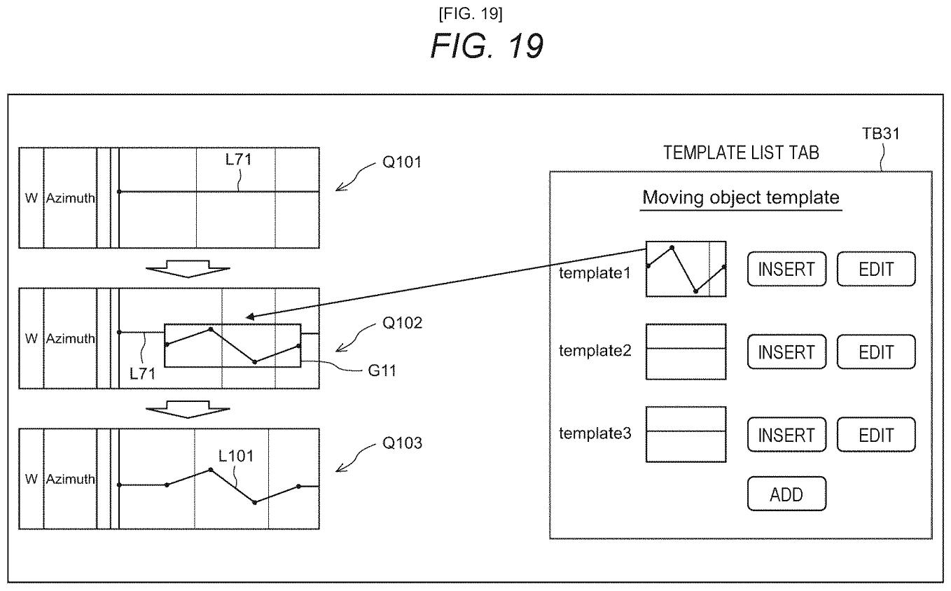

On the other hand, in the pasting priority mode, for example, as illustrated in FIG. 19, not only the pasting destination section of the graph of the change pattern but also the values of the output parameters before and after the pasting destination section are completely overwritten. Specifically, the values of the output parameters before and after the pasting destination section are rewritten to the values of the output parameters of the end portion in the graph of the change pattern to be pasted.

In the example of FIG. 19, the graph of the change pattern is pasted to the graph L71 of the azimuth as the output parameter indicated by an arrow Q101 as indicated by an arrow Q102. In the portion indicated by the arrow Q102, the graph of the change pattern is pasted to the portion of a section G11.

Therefore, the graph of the azimuth changes as indicated by an arrow Q103. In the portion indicated by the arrow Q103, a graph L101 of the azimuth after the change by pasting of the graph of the change pattern is illustrated.

In the graph L101, the value of the azimuth in the portion temporally before the portion of the section G11, that is, the portion on the left side in the drawing, is changed to the value of the azimuth at the end on the left side in the drawing of the portion of the section G11, that is, the value of the azimuth at the end on the left side of the pasted graph.

Similarly, the value of the azimuth in the portion temporally after the portion of the section G11 of the graph L101, that is, the portion on the right side in the drawing, is changed to the value of the azimuth at the end on the right side in the drawing of the portion of the section G11, that is, the value of the azimuth at the end on the right side of the pasted graph.

In this way, by changing the values (output parameters) of the sections before and after the section to which the graph is pasted according to the pasting of the graph of the change pattern, it is possible to obtain an output parameter that changes more naturally with time.

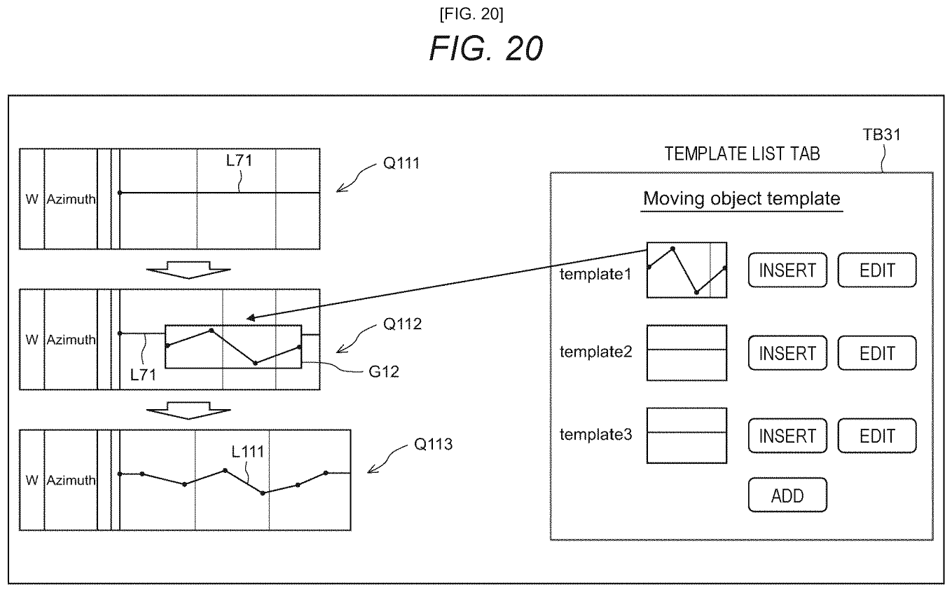

Furthermore, in the interpolation mode, for example, as illustrated in FIG. 20, interpolation processing based on the values of the output parameters before and after the pasting destination section of the graph of the change pattern and the value of the output parameter in the graph to be pasted is performed. Therefore, in the interpolation mode, the value of the output parameter transitions over time before and after the pasting of the graph. Note that the interpolation processing method may be linear interpolation or another known method such as quadratic interpolation or non-linear interpolation.

In the example of FIG. 20, the graph of the change pattern is pasted to the graph L71 of the azimuth as the output parameter indicated by an arrow Q111 as indicated by an arrow Q112. In the portion indicated by the arrow Q112, the graph of the change pattern is pasted to the portion of a section G12.

Therefore, the graph of the azimuth changes as indicated by an arrow Q113. In the portion indicated by the arrow Q113, a graph L111 of the azimuth after the change by pasting of the graph of the change pattern is illustrated.

In the graph L111, the value of the azimuth in the portion temporally before the portion of the section G12 (the portion on the left side) is the value obtained by the interpolation processing based on the value of the azimuth at the left end of the pasted graph and the value of the azimuth in the portion temporally before the section G12 in the graph L71. As a result, in the portion temporally before the section G12 in the graph L111, the value of the azimuth gradually changes from the value of the azimuth in the portion temporally before the section G12 in the graph L71 to the value of the azimuth at the left end of the pasted graph.

Similarly, the value of the azimuth in the portion temporally after the portion of the section G12 in the graph L111 (the portion on the right side) is the value obtained by the interpolation processing based on the value of the azimuth at the right end of the pasted graph and the value of the azimuth in the portion temporally after the section G12 in the graph L71. As a result, in the portion temporally after the section G12 in the graph L111, the value of the azimuth gradually changes from the value of the azimuth at the right end of the pasted graph to the value of the azimuth in the portion temporally after the section G12 in the graph L71.

In this way, by performing the interpolation processing according to the pasting of the graph of the change pattern and changing the values (output parameters) of the sections before and after the section to which the graph is pasted, it is possible to obtain an output parameter that changes more naturally with time.

Note that in a case where the graph of the change pattern is pasted, in each of the sections before and after the pasting destination, the connection method, that is, which of the pasting destination priority mode, the pasting priority mode, and the interpolation mode is selected (set) may be individually selected (set) for every section.

Furthermore, when the user can change the connection method or store the connection method after the change, the adjustment time of the output parameter (change point) after pasting the graph of the change pattern can be further reduced.

In addition, for example, the information processing apparatus 11 has a function of performing assistance in determining the position in the vertical direction or the lateral direction to which the graph of the change pattern is to be pasted, so that the pasting position easily follows the musical configuration.

For example, in the graph (timeline) of the output parameter, the value of the output parameter can be displayed in units of bars or beats instead of in units of samples or seconds in the time direction. Furthermore, the start and end of the graph of the change pattern are assisted so as to easily match the timing matching the beat.

In this case, for example, the output parameter calculation unit 66 (control unit 26) may determine a section in which the output parameter is determined on the basis of the change pattern designated by the user, in other words, a section in which the change parameter is pasted, in the reproduction section of the audio data of the object, in units of bars or beats. In addition, for example, in the graph (timeline) of the output parameter, an auxiliary line or the like may be displayed at a position (time) in units of bars or beats.

Moreover, assistance may be performed by utilizing information regarding other tracks. For example, in a case where there is a kick track, the pasting position of the graph of the change pattern may be easily adjusted to match the sound production timing of the kick. Therefore, it is possible to insert (paste) the graph of the change pattern that does not deviate from the musical configuration, and it is possible to reduce the temporal cost for adjusting the change point and the like.

In this case, for example, the output parameter calculation unit 66 (control unit 26) may determine a section in which the output parameter is determined on the basis of the change pattern designated by the user, in other words, a section in which the change parameter is pasted, in the reproduction section of the audio data of the object, on the basis of the sound generation timing or the like of another object belonging to another track, such as a kick, different from the track to which the object belongs. In addition, for example, in the graph (timeline) of the output parameter, an auxiliary line or the like may be displayed at the position (time) of the sound production timing of the kick.

Furthermore, in the example described above, a case has been described in which the graph of the change pattern is pasted (inserted) for one output parameter, such as the azimuth, constituting the metadata. However, the present invention is not limited thereto, and it is also possible to collectively paste the graph of the change pattern by one operation for a plurality of output parameters.

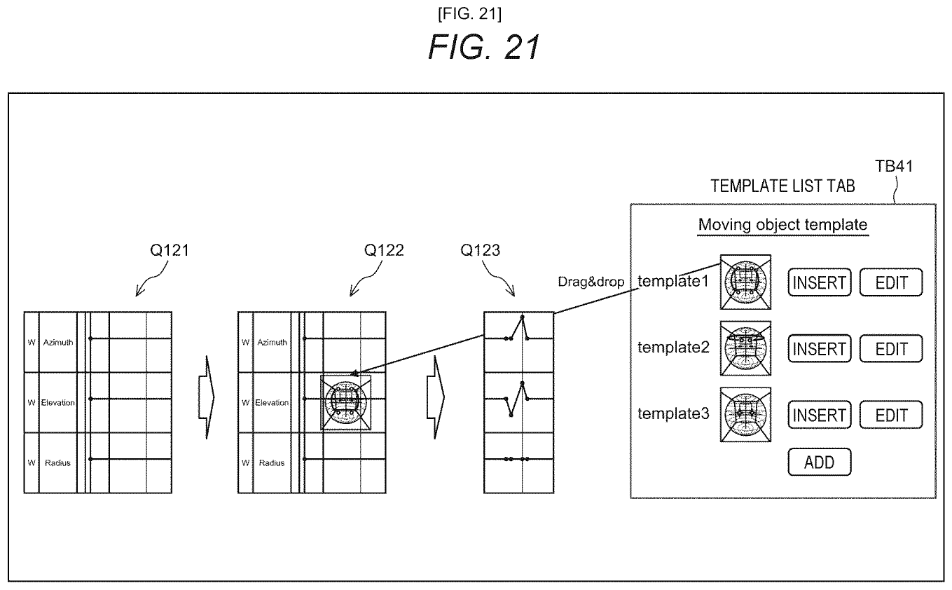

In such a case, for example, a template list tab TB41 illustrated in FIG. 21 is displayed as the GUI on the display unit 22.

The template list tab TB41 displays a list of change patterns registered in advance. In particular, here, information regarding each change pattern is stored as the motion of the moving object.

On the template list tab TB41, a name of a change pattern such as “template 1”, an image (hereinafter, also referred to as a template image) indicating the motion of the moving object in the change pattern, an insertion button, an edit button, and the like are arranged and displayed for every change pattern. In this example, one change pattern indicating the motion of the object is registered as one template.

For example, in the template image, similarly to the example described with reference to FIGS. 2, 3, 4, and the like, the direction of movement of the moving object or the size of the moving range in the three-dimensional space are displayed by arrows or the like. Therefore, only by viewing the template image, the user can visually grasp how the object moves (moves) when the change pattern (template) is applied.

For example, it is assumed that the control unit 26 controls the display unit 22 to display a display screen indicated by an arrow Q121 in FIG. 21 on the display unit 22.

In the portion indicated by the arrow Q121, each of the azimuth, the elevation, and the radius of the object at each time is graphically displayed (timeline display) as the time-series output parameter of the predetermined object.

In a case where the user collectively changes the three output parameters of one object, that is, the azimuth, the elevation, and the radius, the user selects a desired template (change pattern) from the template list tab TB41.

Then, the user operates the input unit 21 as indicated by an arrow Q122 to drag and drop the template image of the template (change pattern) selected by the template list tab TB41 to the portion of the section to be changed on the graph (timeline) of the output parameter. Note that pasting may be performed by an operation other than drag-and-drop.

Therefore, the graph of the output parameter corresponding to the template image can be pasted to the section in which the template image is dragged and dropped, on the graph (timeline) of each output parameter of the azimuth, the elevation, and the radius.

In this case, for example, a graph indicated by an arrow Q123 is pasted to each of the graph of the azimuth, the graph of the elevation, and the graph of the radius.

In the example illustrated in FIG. 16, the graph of the change pattern is pasted to the graph (timeline) of one output parameter. On the other hand, in the example of FIG. 21, each of the graphs of three output parameters in the template is pasted to each of the graphs of the three output parameters by one operation.

In this case, when the input unit 21 is operated by the user and the drag-and-drop operation of the template image is performed, a signal corresponding to the operation is supplied from the input unit 21 to the output parameter calculation unit 66 (control unit 26).

The output parameter calculation unit 66 generates three output parameters of the object according to the signal from the input unit 21 and supplies the three output parameters to the output parameter adjustment unit 67. For example, in the example of FIG. 21, the azimuth, the elevation, and the radius at each time that change in time series as indicated by the arrow Q123 in a partial section are generated as output parameters that change in time series. Note that, although not illustrated here, a gain that changes in time series in accordance with the movement of the object is also generated as the output parameter.

As described above, by storing the change pattern in the form of the motion of the object as the template, it is possible to insert the graphs (the shape of the temporal change) of the plurality of output parameters in a unified manner. Thus, it is possible to more easily perform editing and the like of the output parameter in a short time.

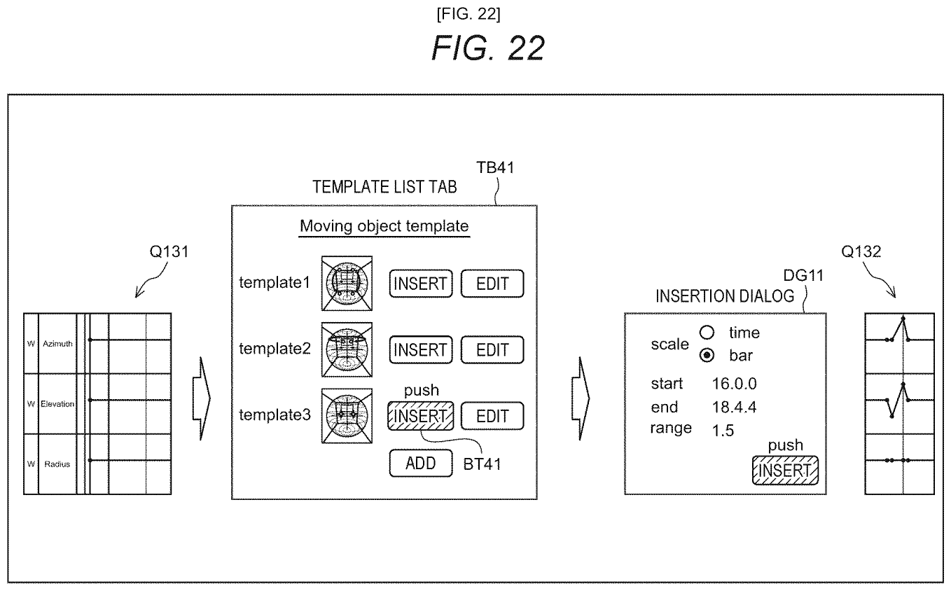

The timing and length of insertion (pasting) of the graph of the output parameter corresponding to the template, and the magnification of the change amount of the output parameter may be input as numerical values, or may be set via an insertion dialog as illustrated in FIG. 22, for example. Note that, in FIG. 22, portions corresponding to those in the case of FIG. 21 are denoted by the same reference numerals, and the description thereof will be omitted as appropriate.

In the example of FIG. 22, as indicated by an arrow Q131, the template list tab TB41 is used similarly to the example of FIG. 21 when changing (editing) the graph (timeline) of the azimuth, the elevation, and the radius as the output parameters.

At this time, the user can cause an insertion dialog DG11 to be displayed on the display unit 22 for the template by operating an insertion button BT41 on the template list tab TB41.

In the insertion dialog DG11, the user can directly designate the selection of the unit “scale” related to the time of the timing of inserting (pasting) the graph of the change pattern into the graph (timeline), the start position “start” of the pasting section, the end position “end” of the pasting section, and the magnification “range” of the change amount of the output parameter.

For example, here, as the unit “scale” related to time, either a time unit “time” which is a second unit or a bar unit “bar” can be selected.

Furthermore, the magnification “range” of the change amount indicates how many times greater the amount of change in the output parameter is compared to a predetermined reference value of the change amount of the output parameter. The change amount here is the amount of change in a vertical axis direction in the graph (timeline) of the output parameter.

The user performs an operation on the insertion dialog DG11 to select the unit “scale” related to time or input numerical values of the start position “start” and the end position “end”, and then presses the insertion button provided in the insertion dialog DG11.

Then, the signal corresponding to the operation by the user is supplied from the input unit 21 to the output parameter calculation unit 66 (control unit 26).

According to the signal from the input unit 21, the output parameter calculation unit 66 generates the output parameter of the object that changes in time series, on the basis of the unit “scale”, the start position “start”, the end position “end”, and the magnification “range” designated by the user, and supplies the generated output parameter to the output parameter adjustment unit 67.

Therefore, for example, as indicated by an arrow Q132, the azimuth, the elevation, and the radius are generated as the output parameters. Furthermore, the gain may also be generated as an output parameter. When the output parameter is generated, the control unit 26 controls the display unit 22 to display the graph of the generated output parameter on the display screen.

Note that in the above-described method of inserting (pasting) the graph of the change pattern, the determination of the change pattern and the determination of the insertion place are entrusted to the user. However, the present invention is not limited thereto, and only one of the change pattern and the insertion place may be determined by the user, and the other may be automatically determined by the algorithm described in “3. Automatic Application of Change Pattern By Algorithm”.

For example, when the user designates a change pattern to be automatically applied, the change pattern may be applied to a section matching (suitable for) the change pattern specified by the user by the algorithm described in “3. Automatic Application of Change Pattern By Algorithm”.

Conversely, the target section may be designated by the user, and the subsequent processing, that is, the processing after step S16 in FIG. 9 may be automatically performed by the algorithm described in “3. Automatic Application of Change Pattern By Algorithm”.

In this case, when the user performs an operation of designating the target section by the input unit 21, the application pattern determination unit 65 divides the reproduction section of the audio data of the object into a plurality of target sections according to the user operation. Then, thereafter, the automatic mixing apparatus performs the processing of steps S16 to S20 in FIG. 9. That is, the change pattern (application pattern) to be applied to each target section is determined by the algorithm, the application pattern is applied to each target section, and the output parameter that changes in time series according to the application pattern is generated for every target section.

### 4.2. Addition of Change Pattern

The user may be allowed to add an arbitrary change pattern. Note that the change pattern here includes a pattern indicating a temporal change of one output parameter such as the azimuth among patterns corresponding to the motion of the moving object such as the above-described “vertical movement”, a pattern indicating a representative temporal change of one output parameter, or the like.

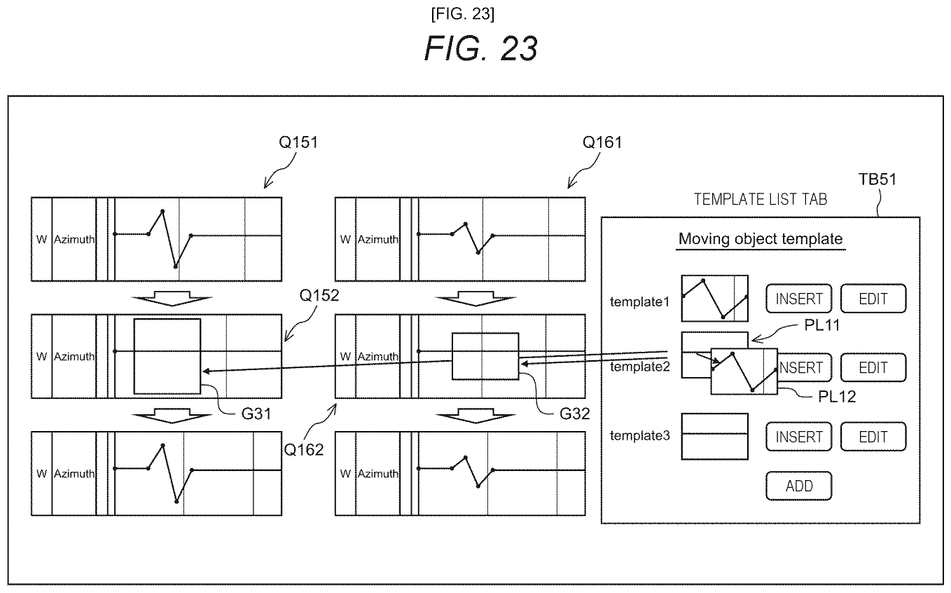

FIG. 23 illustrates an example of the case where the change pattern is added.

In this example, for example, a template list tab TB51 similar to the example illustrated in FIG. 16 is displayed on the display unit 22. In particular, in addition to the graph indicating the registered change pattern, a graph PL11 of a blank template (change pattern) for registering the change pattern as a new template is also displayed on the template list tab TB51.

For example, as indicated by an arrow Q151, it is assumed that the graph (timeline) of the azimuth as the output parameter is displayed on the display unit 22.

In such a state, it is assumed that the user operates the input unit 21 as indicated by an arrow Q152 to drag and drop and paste the blank graph PL11 in the template list tab TB51 so as to overlap with a partial section G31 of the graph of the azimuth, more specifically, the section G31 including the already-created change point group in the graph. Therefore, the partial section G31 of the graph of the azimuth is designated by the user. Note that pasting may be performed by an operation other than drag-and-drop.

Then, in the output parameter calculation unit 66, according to the user operation, the change in time series of the azimuth in the section G31 in which the blank graph PL11 is dragged and dropped is registered (stored) as a new change pattern, that is, a pattern of a temporal change of a new output parameter.

Furthermore, the display of the portion of the graph PL11 that is blank in the template list tab TB51 changes to a graph PL12 indicating the registered change pattern. After the change pattern is registered, the graph (timeline) of the azimuth returns to the original display as illustrated in the lower left of the drawing.

As another example, for example, as indicated by an arrow Q161, it is assumed that the graph (timeline) of the azimuth as the output parameter is displayed on the display unit 22.

In this state, when the user drags and drops the blank graph PL11 so as to overlap with a partial section G32 of the graph of the azimuth as indicated by an arrow Q162, the change in time series of the azimuth in the section G32 is registered (stored) as a new change pattern.

Furthermore, after the change pattern is registered, the graph (timeline) of the azimuth returns to the original display as illustrated in the lower center in the drawing.

In particular, in the example indicated by the arrow Q162, the length in the vertical direction of the designated section G32 is different from that in the section G31. The user can change the range of the change pattern to be stored, by changing the width and height of the blank graph PL11 at the time of performing pasting (drag-and-drop). In this case, the shape of the change pattern is normalized in accordance with the size (length) in the vertical direction and the lateral direction of the section G31 and the section G32 where the pasting has been performed, and is stored as a template.

Furthermore, when a new change pattern is added, it is also possible to designate and store how to connect (connection method) described in “4.1. Insertion of Pattern”. The connection method stored at the time of registering the change pattern is reflected (used) when this change pattern (template) is used in the following.

Moreover, the newly added change pattern may be automatically added to the change pattern (application pattern) described in “3.6. Determination of Application Pattern” or to the rule of application of the application pattern by being stored together with the waveform information or the analysis result such as the object category and performing the reverse analysis. By doing so, the algorithm can be automatically optimized for the individual, and the new change pattern optimized for the individual can also be applied by the algorithm.

### 4.3. Editing of Change Pattern

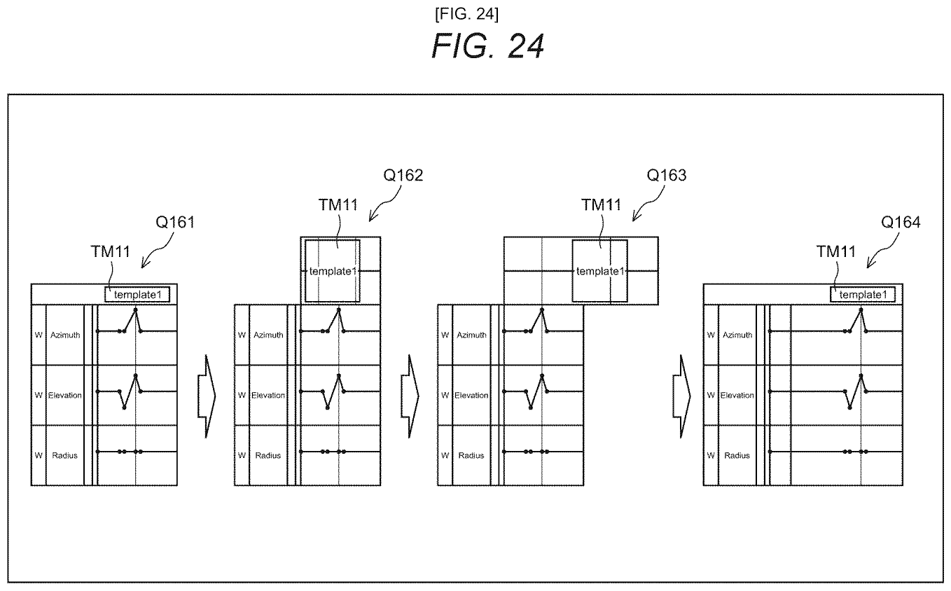

FIG. 24 illustrates an example of editing the change pattern.

For example, it is assumed that time-series changes of the azimuth, the elevation, and the radius as the output parameters are newly added (registered) as one change pattern “template1”. In this case, it is convenient to have a function of collectively editing each output parameter (change point) in the change pattern after registration.

At the time of editing the output parameter or the like, the portion of the newly registered change pattern “template1” is displayed in the graph of the output parameter (the graph of the change point) as indicated by the arrow Q161, for example. In this example, a rectangular region TM11 indicating the change pattern “template1” is displayed together with the graph. The rectangular region TM11 indicates a section to which the change pattern “template1” has already been applied (pasted).

When the user designates the portion of the rectangular region TM11 by clicking or the like, as indicated by the arrow Q162, the graph of the pasted template (change pattern) and the change point is expanded similarly to the insertion of the change pattern (template).

Then, similarly to the insertion of the template, the user can collectively edit the change pattern (change point group) and confirm the editing by changing the size (length) in the vertical direction or the lateral direction of the rectangular region TM11 or shifting the arrangement position of the rectangular region TM11.

For example, in a case where it is desired to shift the entire position of the change pattern rearward in the time direction, the user clicks the pasted change pattern, that is, the rectangular region TM11, shifts the expanded figure (the rectangular region TM11) as indicated by an arrow Q163 rearward in the time direction, and confirms the editing.

Therefore, as indicated by an arrow Q164, the position of the change point in each output parameter also changes according to the change in the arrangement position of the rectangular region TM11. That is, a plurality of change points can be collectively shifted to the rear side in the time direction.

Furthermore, for example, the user can insert the change pattern in which the motion is extended in the time direction again by laterally extending the shape of the rectangular region TM11 and confirming the editing again.

As described above, the user can edit the change pattern, that is, the change point group of one or more output parameters collectively even after the insertion by editing the change pattern similarly to the insertion of the change pattern (template) and confirming the editing again.

In such a case, for example, as illustrated in FIG. 24, the control unit 26 causes the graph of the time-series output parameter determined (edited) once, that is, the graph of the determined output parameter to be displayed on the display screen of the display unit 22.

It is assumed that in a state where the graph of the output parameter is displayed, the user performs an operation on the display screen, more specifically, the graph of the output parameter by using the input unit 21, changes (edits) the output parameter (change point group), and confirms the change. Then, a signal corresponding to the user operation is supplied from the input unit 21 to the control unit 26 (output parameter calculation unit 66), and the output parameter calculation unit 66 changes the output parameter according to the signal from the input unit 21.

Note that, for example, as in the example of FIG. 24, it is possible to collectively edit the output parameter, that is, the change point group in units of application patterns (change patterns), considering a plurality of output parameters simultaneously as processing targets. In such a case, the output parameter calculation unit 66 collectively changes, for example, a plurality of output parameters of the same object in units of application patterns, that is, in units of sections corresponding to the application patterns.

### 5. Related Art

### 5.1. Change Pattern or Share of Decision Tree

The rule and the change pattern of the decision tree newly added and edited by the user in “3. Automatic Application Of Change Pattern by Algorithm” and “4. Pattern Application by GUI Operation” described above are elements in which the user's artistry appears.

In this regard, by sharing the rule and the change pattern of the decision tree with other users, many people can use the idea and technology of each user for mixing.

For example, if such sharing is performed, a user who has not experienced mixing of 3D audio can try various well-known mixing engineers' knowhow in producing moving objects. Furthermore, it is also conceivable to perform learning using a change pattern of a well-known mixing engineer as a teaching material in a place of education of 3D audio production.

As a method of sharing, for example, each new change pattern or decision tree may be stored in a file format, and sharing may be realized by local file sharing. Furthermore, sharing may be realized by a creator uploading a file on a cloud and each user accessing the cloud to download the file.

### 5.2. Generation of Parameter Used for Signal Processing and Changing in Time Series

In the above, an example has been described in which the production support of the time-series change of the three-dimensional position or the gain of the object as the output parameter (metadata) is performed. However, the time-series change of the parameter necessary for the signal processing such as the equalizer processing performed on each track may be generated. That is, a parameter used for signal processing such as equalizer processing performed on the audio data of the object may be generated as the output parameter that changes in time series.

For example, by a method similar to the method described in “3. Automatic Application of Change Pattern by Algorithm”, the pattern of the equalizer processing may be associated with a predetermined target section by a decision tree using an arbitrary rule. In such a case, the signal processing may be performed on the sound in the target section by applying, to the target section, the parameter change of the equalizer processing determined by the user or prepared in advance.

### Configuration Example of Computer

Incidentally, the above-described series of processing can be executed by hardware or software. In a case where a series of processing is executed by the software, a program forming the software is installed on a computer. Here, examples of the computer include a computer incorporated in dedicated hardware, and for example, a general-purpose personal computer capable of executing various functions by installing various programs or the like.

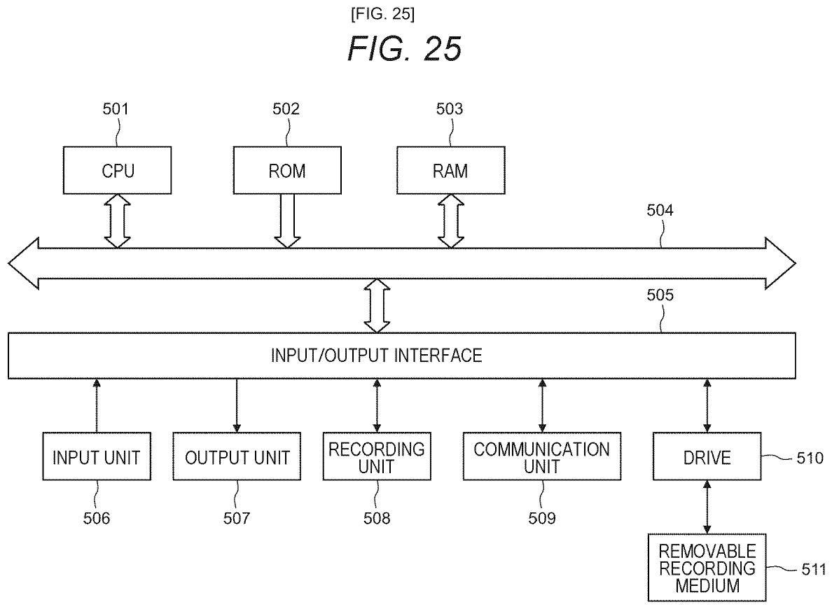

FIG. 25 is a block diagram illustrating a configuration example of hardware of a computer that executes the above-described series of processing by a program.

In the computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an imaging device, and the like. The output unit 507 includes a display, a speaker, and the like. The recording unit 508 includes a hard disk, a non-volatile memory and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input/output interface 505 and the bus 504, and executes the program, so as to perform the above-described series of processing.

The program executed by the computer (CPU 501) can be provided by being recorded on the removable recording medium 511 as a package medium and the like, for example. Furthermore, the program can be provided via a wired or wireless transfer medium such as a local area network, the Internet, or digital satellite broadcasting.

In the computer, the program can be installed in the recording unit 508 via the input/output interface 505 by mounting the removable recording medium 511 on the drive 510. Furthermore, the program can be received by the communication unit 509 via the wired or wireless transmission medium to be installed on the recording unit 508. In addition, the program can be installed in the ROM 502 or the recording unit 508 in advance.

Note that the program executed by the computer may be a program in which processing is performed in time series in the order described in the present specification, or may be a program in which processing is performed in parallel or at necessary timing such as when a call is made.

Furthermore, the embodiments of the present technology are not limited to the above-described embodiments, and various modifications are possible without departing from the scope of the present technology.

For example, the present technology can have a configuration of cloud computing in which one function is shared and processed in cooperation by a plurality of apparatuses via a network.

Furthermore, each step described in the flowchart described above can be performed by one apparatus or can be shared and performed by a plurality of apparatuses.

Moreover, in a case where a single step includes a plurality of pieces of processing, the plurality of pieces of processing included in the single step can be performed by a single apparatus or performed by a plurality of apparatuses in a shared manner.

Moreover, the present technology may also have following configurations.
(1)

An information processing apparatus including:
a control unit that determines an output parameter, which changes in time series, of an object of content on the basis of one or more pieces of attribute information of the content or the object.
(2)

The information processing apparatus according to (1), in which
the content is 3D audio content.
(3)

The information processing apparatus according to (1) to (2), in which
the output parameter is at least one of three-dimensional position information, a gain, a priority, or a spread of the object.
(4)

The information processing apparatus according to (1) to (2), in which
the output parameter is a parameter used for signal processing performed on audio data of the object.
(5)

The information processing apparatus according to any one of (1) to (4), in which
the control unit calculates the attribute information on the basis of audio data of the object.
(6)

The information processing apparatus according to any one of (1) to (5), in which
the attribute information is a content category indicating a type of the content, an object category indicating a type of the object, or an object feature amount indicating a feature of the object.
(7)

The information processing apparatus according to (6), in which
the attribute information is represented by a character or a numerical value that is understandable to a user.
(8)

The information processing apparatus according to any one of (1) to (7), in which
the control unit divides a reproduction section of audio data of the object into a plurality of target sections on the basis of the attribute information, and determines the output parameter for each of the target sections on the basis of the attribute information.
(9)

The information processing apparatus according to any one of (1) to (7), in which
the control unit determines, as an application pattern, one change pattern among a plurality of change patterns for changing the output parameter in time series on the basis of the attribute information, and determines the output parameter on the basis of the application pattern and the attribute information.
(10)

The information processing apparatus according to (9), in which
the control unit divides a reproduction section of audio data of the object into a plurality of target sections the basis of the attribute information, and determines the application pattern for each of the target sections on the basis of the attribute information.
(11)

The information processing apparatus according to (10), in which
the control unit determines the target section, which is valid, among a plurality of the target sections on the basis of the attribute information, and determines the output parameter of the target section which is valid, on the basis of the application pattern and the attribute information.
(12)

The information processing apparatus according to (11), in which
the control unit determines the output parameter, which does not change in time series, for the target section which is invalid, on the basis of the attribute information.
(13)

The information processing apparatus according to any one of (9) to (12), in which
a plurality of the change patterns include at least one of a pattern for emphasizing a change in sound in an up-down direction, a pattern for emphasizing a change in sound in a left-right direction, a pattern in which sound slightly moves up, down, left, and right, a pattern in which a position of sound instantaneously moves, or a pattern in which a position of sound freely moves.
(14)

The information processing apparatus according to any one of (9) to (13), in which
the change pattern is able to be edited by a user.
(15)

The information processing apparatus according to (14), in which
the change pattern is able to be added or deleted by the user.
(16)

The information processing apparatus according to any one of (1) to (15), in which
an algorithm for determining the output parameter on the basis of the attribute information is able to be edited by a user.
(17)

The information processing apparatus according to any one of (1) to (16), in which
the control unit adjusts the output parameter of the object on the basis of a determination result of the output parameter obtained for a plurality of the objects.
(18)

The information processing apparatus according to any one of (1) to (7), in which
the control unit uses, as an application pattern, a change pattern designated by a user among a plurality of change patterns for changing the output parameter in time series and determines the output parameter on the basis of the application pattern and the attribute information.
(19)

The information processing apparatus according to (18), in which
the control unit determines a section, in which the output parameter is determined on the basis of the application pattern designated by the user, among reproduction sections of audio data of the object in units of bars or in units of beats.
(20)

The information processing apparatus according to (18) or (19), in which
the control unit determines a section, in which the output parameter is determined on the basis of the application pattern designated by the user, among reproduction sections of audio data of the object, on the basis of a sound generation timing of another object different from the object.
(21)

The information processing apparatus according to any one of (1) to (7), in which
the control unit divides a reproduction section of audio data of the object into a plurality of target sections according to a user operation, and determines the output parameter for each of the target sections on the basis of the attribute information.
(22)

The information processing apparatus according to any one of (1) to (21), in which
the control unit causes the determined output parameter in time series to be displayed on a display screen, and changes the output parameter according to a user operation on the display screen.
(23)

An information processing method, in which
an information processing apparatus
determines an output parameter, which changes in time series, of an object of content on the basis of one or more pieces of attribute information of the content or the object.
(24)

A program for causing a computer to execute processing including:
a step of determining an output parameter, which changes in time series, of an object of content on the basis of one or more pieces of attribute information of the content or the object.
(25)

An information processing apparatus including:
a control unit that determines, as an application pattern, one change pattern among a plurality of change patterns for changing in time series an output parameter of an object of content according to a user operation, and determines the output parameter, which changes in time series, of the object on the basis of the application pattern.
(26)

The information processing apparatus according to (25), in which
the control unit determines a section, in which the output parameter is determined on the basis of the application pattern designated by the user, among reproduction sections of audio data of the object in units of bars or in units of beats.
(27)

The information processing apparatus according to (25) or (26), in which
the control unit determines a section, in which the output parameter is determined on the basis of the application pattern designated by the user, among reproduction sections of audio data of the object on the basis of a sound generation timing of another object different from the object.
(28)

The information processing apparatus according to any one of (25) to (27), in which
the content is 3D audio content.
(29)

The information processing apparatus according to any one of (25) to (28), in which
the output parameter is at least one of three-dimensional position information, a gain, a priority, or a spread of the object.
(30)

The information processing apparatus according to any one of (25) to (28), in which
the output parameter is a parameter used for signal processing performed on audio data of the object.
(31)

The information processing apparatus according to any one of (25) to (30), in which
a plurality of the change patterns include at least one of a pattern for emphasizing a change in sound in an up-down direction, a pattern for emphasizing a change in sound in a left-right direction, a pattern in which sound slightly moves up, down, left, and right, a pattern in which a position of sound instantaneously moves, or a pattern in which a position of sound freely moves.
(32)

The information processing apparatus according to any one of (25) to (31), in which
the change pattern is able to be edited by the user.
(33)

The information processing apparatus according to (32), in which
the change pattern is able to be added or deleted by the user.
(34)

The information processing apparatus according to any one of (25) to (33), in which
the control unit causes the determined output parameter in time series to be displayed on a display screen, and changes the output parameter in units of sections corresponding to the application pattern according to a user operation on the display screen.
(35)

An information processing method, in which
an information processing apparatus
determines, as an application pattern, one change pattern among a plurality of change patterns for changing in time series an output parameter of an object of content according to a user operation, and determines the output parameter, which changes in time series, of the object on the basis of the application pattern.
(36)

A program for causing a computer to execute processing including:
a step of determining, as an application pattern, one change pattern among a plurality of change patterns for changing in time series an output parameter of an object of content according to a user operation, and determining the output parameter, which changes in time series, of the object on the basis of the application pattern.

### REFERENCE SIGNS LIST

11 Information processing apparatus
21 Input unit
22 Display unit
26 Control unit
61 Audio data reception unit
62 Object feature amount calculation unit
63 Object category calculation unit
64 Content category calculation unit
65 Application pattern determination unit
66 Output parameter calculation unit
67 Output parameter adjustment unit
68 Output parameter output unit

1. An information processing apparatus comprising:
a control unit that determines an output parameter, which changes in time series, of an object of content on a basis of one or more pieces of attribute information of the content or the object.

2. The information processing apparatus according to claim 1, wherein
the content is 3D audio content.

3. The information processing apparatus according to claim 1, wherein
the output parameter is at least one of three-dimensional position information, a gain, a priority, or a spread of the object.

4. The information processing apparatus according to claim 1, wherein
the output parameter is a parameter used for signal processing performed on audio data of the object.

5. The information processing apparatus according to claim 1, wherein
the control unit calculates the attribute information on a basis of audio data of the object.

6. The information processing apparatus according to claim 1, wherein
the attribute information is a content category indicating a type of the content, an object category indicating a type of the object, or an object feature amount indicating a feature of the object.

7. The information processing apparatus according to claim 1, wherein
the control unit divides a reproduction section of audio data of the object into a plurality of target sections on a basis of the attribute information, and determines the output parameter for each of the target sections on a basis of the attribute information.

8. The information processing apparatus according to claim 1, wherein
the control unit determines, as an application pattern, one change pattern among a plurality of change patterns for changing the output parameter in time series on a basis of the attribute information, and determines the output parameter on a basis of the application pattern and the attribute information.

9. The information processing apparatus according to claim 8, wherein
the control unit divides a reproduction section of audio data of the object into a plurality of target sections on a basis of the attribute information, and determines the application pattern for each of the target sections on a basis of the attribute information.

10. The information processing apparatus according to claim 9, wherein
the control unit determines the target section, which is valid, among a plurality of the target sections on a basis of the attribute information, and determines the output parameter of the target section which is valid, on a basis of the application pattern and the attribute information.

11. The information processing apparatus according to claim 10, wherein
the control unit determines the output parameter, which does not change in time series, for the target section which is invalid, on a basis of the attribute information.

12. The information processing apparatus according to claim 8, wherein
a plurality of the change patterns include at least one of a pattern for emphasizing a change in sound in an up-down direction, a pattern for emphasizing a change in sound in a left-right direction, a pattern in which sound slightly moves up, down, left, and right, a pattern in which a position of sound instantaneously moves, or a pattern in which a position of sound freely moves.

13. The information processing apparatus according to claim 8, wherein
the change pattern is able to be edited by a user.

14. The information processing apparatus according to claim 13, wherein
the change pattern is able to be added or deleted by the user.

15. The information processing apparatus according to claim 1, wherein
an algorithm for determining the output parameter on a basis of the attribute information is able to be edited by a user.

16. The information processing apparatus according to claim 1, wherein
the control unit adjusts the output parameter of the object on a basis of a determination result of the output parameter obtained for a plurality of the objects.

17. An information processing method, wherein
an information processing apparatus
determines an output parameter, which changes in time series, of an object of content on a basis of one or more pieces of attribute information of the content or the object.

18. A program for causing a computer to execute processing comprising:
a step of determining an output parameter, which changes in time series, of an object of content on a basis of one or more pieces of attribute information of the content or the object.

19. An information processing apparatus comprising:
a control unit that determines, as an application pattern, one change pattern among a plurality of change patterns for changing in time series an output parameter of an object of content according to a user operation, and determines the output parameter, which changes in time series, of the object on a basis of the application pattern.
